(19) United States
(12) Patent Application Publication
(10) Pub. No.: US 2008/0064610 A1
(43) Pub. Date: Mar. 13, 2008

(54) Nucleic acid library design and assembly

(75) Inventors: Dasa Lipovsek, Cambridge, MA (US); Brian M. Baynes, Cambridge, MA (US)

Correspondence Address: WOLF GREENFIELD & SACKS, P.C., 600 ATLANTIC AVENUE, BOSTON, MA, 02210-2206, US

(73) Assignee: Codon Devices, Cambridge, MA (US)

(21) Appl. No.: 11/804,891

(22) Filed: May 21, 2007

Related U.S. Application Data
(60) Provisional application No. 60/801,884, filed on May 20, 2006.

(51) Int. Cl. C40B 50/06

(52) U.S. Cl. 506/26

(57) ABSTRACT

Aspects of the invention relate to the design and synthesis of nucleic acid libraries. Certain embodiments relate to the design and synthesis of nucleic acid libraries that express polypeptides. In some embodiments, the invention provides methods for analyzing polypeptide sequences and identifying those that may confer undesirable properties in vivo (e.g., poor solubility, high immunogenicity, low stability, etc.). In some embodiments, the invention provides methods for synthesizing a library of nucleic acids having predetermined sequences (e.g., a library of nucleic acids that encode polypeptides having related sequences with predetermined sequence variations).

### RELATED APPLICATIONS

This application claims the benefit under 35 U.S.C. §119(e) from U.S. provisional application Ser. No. 60/801,884, filed May 20, 2006, the entire contents of which are herein incorporated by reference.

### FIELD OF THE INVENTION

Methods and compositions of the invention relate to nucleic acid library design and assembly, and particularly to the design and assembly of nucleic acid libraries that express polypeptides.

### BACKGROUND

In vitro protein evolution and selection methods (e.g., phage, yeast, mRNA, and ribosome display) have been used to identify proteins with desired functional properties, such as binding affinity for a macromolecular target or an enzymatic activity. Regardless of the method used, an initial step typically involves generating libraries of nucleic acids with sequences that encode polypeptides that are related to an original protein scaffold but that differ from an original protein sequence. Subsequently, each of the nucleic acids may be transcribed and translated into a corresponding protein. Associated nucleic-acid-protein complexes are then exposed to a target or substrate of interest, and those variants that bind the target with a desired affinity or that have a desired catalytic activity are isolated. Selected proteins can be produced on a large scale, typically in a microbial or mammalian-cell expression system, purified and used as affinity reagents, therapeutic proteins, or designer enzymes.

### SUMMARY OF THE INVENTION

Aspects of the invention relate to expression libraries that can be used to evaluate, screen, or select polypeptides of interest. In some embodiments the invention relates to expression libraries that can be used to screen or select for polypeptides having one or more functional and/or structural properties (e.g., one or more predetermined catalytic, enzymatic, receptor-binding, therapeutic, or other properties). Aspects of the invention provide expression libraries (e.g., nucleic-acid/polypeptide libraries) that are enriched for candidate polypeptides lacking one or more unwanted characteristics. For example, a library that expresses many different polypeptide variants may be designed to exclude polypeptides that have poor in vivo solubility, high immunogenicity, low stability, etc., or any combination thereof. Accordingly, aspects of the invention provide methods of generating filtered expression libraries that are enriched for candidate molecules having physiologically compatible or desirable characteristics. In some embodiments, a filtered expression library may be screened and/or exposed to selection conditions to identify one or more polypeptides having a function or structure of interest.

Accordingly, aspects of the invention may be used to screen or select filtered libraries for target polypeptides of interest that also have desirable in vivo traits. Whereas selection methods using un-filtered libraries may yield proteins with required binding or catalytic properties, they generally do not select for other desirable properties. For example, proteins selected using un-filtered libraries frequently are found to have unacceptably low stability or solubility when purified and characterized. In the case of proteins designed for therapeutic applications, such as antibodies, antibody fragments, non-antibody target-binding proteins, and modified hormones or receptors, a common problem is that proteins selected from unfiltered libraries often evoke an immune response when introduced into patients, causing either inactivation of the putative therapeutic or adverse side effects.

In some embodiments, filtering techniques of the invention can be used to identify nucleic acid sequences to be included in a polypeptide expression library. In some embodiments, filtering techniques of the invention can be used to identify nucleic acid sequences to be excluded from a polypeptide expression library. In some embodiments, methods of the invention are useful for screening nucleic acid sequences that are candidates for inclusion in an expression library and identifying those sequences that encode polypeptides with one or more undesirable properties (e.g., poor solubility, high immunogenicity, low stability, etc.). Accordingly, aspects of the invention may be used to design a library of nucleic acids that encode a plurality of polypeptides having one or more biophysical or biological properties that are known or predicted to be within a predetermined acceptable or desirable range of values.

Aspects of the invention also relate to methods of assembling libraries containing nucleic acids having predetermined sequence variations. In some embodiments, a library may be designed and assembled to be representative of a plurality of predetermined nucleic acid or polypeptide sequences that are selected (e.g., using a sequence filter of the invention) or provided (e.g., provided by a customer). In some embodiments, a library contains a plurality of related nucleic acids that include predetermined sequence differences at only a subset of positions.

A library assembly reaction may include a polymerase and/or a ligase. In some embodiments the assembly reaction involves two or more cycles of denaturing, annealing, and extension conditions. In some embodiments, the library nucleic acid may be amplified, sequenced or cloned after it is made. In some embodiments, a host cell may be transformed with the assembled library nucleic acid. Library nucleic acid may be integrated into the genome of the host cell. In some embodiments, the library nucleic acid may encode a polypeptide. The polypeptide may be expressed (e.g., under the control of an inducible promoter). The polypeptide may be isolated or purified. A cell transformed with an assembled nucleic acid may be stored, shipped, and/or propagated (e.g., grown in culture).

In another aspect, the invention provides methods of obtaining nucleic acid libraries by sending sequence information and delivery information to a remote site. The sequence information may be analyzed at the remote site. Starting nucleic acids may be designed and/or produced at the remote site. The starting nucleic acids may be assembled in a process that generates the desired sequence variation at the remote site. In some embodiments, the starting nucleic acids, an intermediate product in the assembly reaction, and/or the assembled nucleic acid library may be shipped to the delivery address that was provided.

Other aspects of the invention provide systems for designing starting nucleic acids and/or for assembling the starting nucleic acids to make a target library. Other aspects of the invention relate to methods and devices for automating a multiplex oligonucleotide assembly reaction to generate a library of interest. Further aspects of the invention relate to business methods of marketing one or more protocols, systems, and/or automated procedures that involve sequence filtering and/or nucleic acid library assembly. Yet further aspects of the invention relate to business methods of marketing one or more libraries (e.g., one or more filtered libraries).

Other features and advantages of the invention will be apparent from the following detailed description, and from the claims. The claims provided below are hereby incorporated into this section by reference.

### BRIEF DESCRIPTION OF THE FIGURES

FIG. 1 shows one embodiment of a plurality of oligonucleotides that may be assembled in a polymerase-based multiplex oligonucleotide assembly reaction;

FIG. 2 illustrates certain aspects of an embodiment of sequential assembly of a plurality of oligonucleotides in a polymerase-based multiplex assembly reaction;

FIG. 3 illustrates an embodiment of a ligase-based multiplex oligonucleotide assembly reaction;

FIG. 4 illustrates several embodiments of ligase-based multiplex oligonucleotide assembly reactions on supports;

FIG. 5 outlines an embodiment of a method of filtering expression library sequences;

FIG. 6 outlines an embodiment of a method of assembling a nucleic acid library containing predetermined nucleic acid sequence variants; and

FIG. 7 illustrates an embodiment of an assembly technique for producing a pool of predetermined nucleic acid sequence variants.

### DETAILED DESCRIPTION OF THE INVENTION

Aspects of the invention relate to methods for designing and assembling nucleic acid libraries containing a plurality of predetermined nucleic acid sequences. In some embodiments, the invention provides methods for designing and assembling libraries that express a plurality of polypeptides containing predetermined amino acid sequence variants. Aspects of the invention include methods for designing and assembling polypeptide expression libraries that are enriched for polypeptide sequence variants having one or more desirable traits. Aspects of the invention provide methods for filtering nucleic acid sequences to exclude those that express polypeptides having one or more unwanted traits (e.g., poor solubility, immunogenicity, instability, etc., or any combination thereof).

Aspects of the invention also provide methods for assembling an expression library that is representative of predetermined sequences of interest. Accordingly, aspects of the invention also provide expression libraries (e.g., filtered expression libraries), methods of using expression libraries to identify polypeptides having functional or structural properties of interest, and isolated polypeptides and nucleic acids encoding them.

Aspects of the invention are useful for generating pools of different polypeptides containing predetermined amino acid sequence variations. Certain aspects of the invention are useful for generating pools of candidate polypeptides that exclude variants having unwanted biophysical and biological traits. By excluding unwanted traits, a library of the invention may include a higher proportion of potentially useful polypeptide variants. As a result, a candidate polypeptide identified in a screen or selection may be more likely to have appropriate in vivo traits in addition to a functional or structural property of interest.

According to aspects of the invention, a relatively smaller expression library may be generated when unwanted polypeptide variants are excluded. For example, the number of clones required to represent all variants in a library will be smaller if the library is designed to exclude a subset of possible variants that are predicted to have unwanted traits. As a result, a relatively smaller library may be used to screen or select for a function or structure of interest when a subset of sequences is excluded from the library. Alternatively, a library of a predetermined size may be used to represent a higher number of potentially interesting polypeptide variants when unwanted variants are excluded. Accordingly, by excluding amino acid sequences that are predicted to have one or more unwanted traits, aspects of the invention may be useful to generate libraries that represent i) a higher number of potentially useful amino acid substitutions at a predetermined number of positions, or ii) potentially useful amino acid substitutions at more positions, or a combination thereof, relative to libraries that are not filtered. For example, in a filtered library of the invention less than 50%, preferably less than 25%, less than 10%, less than 5%, less than 1%, or even less than 0.1% of expressed polypeptide sequences have one or more undesirable properties (e.g., undesirable levels of immunogenicity, solubility, stability, toxicity, expressibility, or any combination of 2, 3, 4, or 5 thereof).

Accordingly, aspects of the invention may involve imposing certain biophysical and/or biological constraints on the identity of the polypeptides that are expressed by a library. This approach can save time and cost in a screen or selection when compared to a typical approach that involves selecting a population of proteins for a required function (e.g., binding or catalytic activity) and subsequently evaluating each selected protein for stability, solubility, and/or ease of production. When a therapeutic protein is developed, immunogenicity often is evaluated last, and often after a large investment of resources in a candidate protein. In contrast, aspects of the invention may involve pre-filtering libraries for stability, solubility, and/or lack of immunogenicity in the early stages of therapeutic development (e.g., during a library design stage). As a consequence, libraries entering selection may be enriched for stable, soluble, and/or non-immunogenic sequences, leading to a lower incidence of selected proteins having properties that are unacceptable for production, storage, and/or therapeutic administration to a patient.

In some aspects of the invention, a library design may include information that results from a prior functional or structural screen (e.g., of a library of expressed polypeptides). In some embodiments a first library (e.g., a first pre-screened library) may be analyzed or screened for a general favorable, or unfavorable, biological or biophysical trait (e.g., for stability, solubility, lack of toxicity, ease of expression, ease of purification, lack of immunogenicity, etc., or any combination of two or more thereof). In addition, or alternatively, the first library may be screened for a specific desirable, or undesirable, structural and/or functional property or level of activity (e.g., a functional or structural property of level or activity of interest for a therapeutic, industrial, agricultural, and/or other application). A specific property may be a specific enzyme activity, a specific binding property, etc., as opposed to a general trait such as solubility or other general trait.

A first nucleic acid library (e.g., a first pre-screened library) may be expressed and the expressed polypeptides may be evaluated as described above and sequences (e.g., sequence motifs, active sites, scaffolds, etc., or any combination thereof) that are found to impart favorable, or unfavorable, biological or biophysical traits may be identified. Similarly, sequences (e.g., sequence motifs, active sites, scaffolds, etc., or any combination thereof) that are found to impart specific desirable, or undesirable, structural and/or functional properties or levels of activity may be identified. The resulting sequence information may be used to design and/or assemble a second library that differs from the first library in that it is designed to i) contain (e.g., only contain) variants that are predicted to have favorable general biological and/or biophysical traits, ii) contain (e.g., only contain) variants that are predicted to have desirable specific functional and/or structural properties or levels of activity, iii) exclude variants that are predicted to have unfavorable general biological and/or biophysical traits, iv) exclude variants that are predicted to have undesirable specific functional and/or structural properties or levels of activity, or v) any combination of i)-iv).

For example, to screen polypeptide components of the library for stability, each expressed polypeptide can be tested to assess if the polypeptide retains it native structure at increased temperature or at increased concentration of chaotropic reagent. The polypeptide components of the library can be assessed for any desired property. For instance, the immunogenicity of components of the library can be assessed by expressing the polypeptides and contacting immune cells with the polypeptide wherein the assay comprises a specific readout for the an immunogenic response. For instance, polypeptides classified as stable, may all comprise a specific amino acid at a specific position (e.g., an alanine at position 64 of a scaffold sequence of interest). A library optimized (or pre-filtered) for increased stability can than be redesigned to comprise the specific amino acids, amino acid patterns or functional characteristics (e.g., an alpha-helix structure) as a non-variable component (e.g., all library components of the improved library may be designed to have an alanine at position 64).

According to the invention, the information from a screen for a functional or structural trait may be used at the design stage of a subsequent library. In some embodiments, a scaffold may be updated to include features from a functional screen. In some embodiments, information from an initial screen may be used to filter out theoretical variants before they are assembled. For example, certain motifs or sequences determined to be undesired in a first screen may be pre-filtered during a second screen.

In some embodiments, the invention may include methods of analyzing and/or filtering sequences that are predicted, known, or found to confer one or more unwanted traits. In some embodiments, the invention may include methods of designing and/or assembling a library of nucleic acids having predetermined sequence differences (e.g., that encode a predetermined pool of polypeptides having predetermined amino acid changes at predetermined positions). In some embodiments, the identity of different polypeptides that are expressed by a library may be predetermined by analyzing possible amino acid sequence variants and excluding those that are predicted or known to confer one or more unwanted traits. In some embodiments, information obtained from an initial library (e.g., a library that represents a subset of possible variants, even after pre-screening) may be used to alter the design of a subsequent library.

Accordingly, in some embodiments multiple cycles of screening or evaluation can be performed. The polypeptides identified in an initial screen can be analyzed to redesign the library and the redesigned library can be synthesized and further screened or evaluated. The additional screen may have the same cut-off parameters as the first screen. For instance, the expressed polypeptides can be required to have the same stability as in the first screen. In some embodiments, the additional screen may have more stringent cut-off parameters. For instance, if in an initial screen all polypeptides stable in 3M chaotropic reagent are selected, in the additional screen only polypeptides stable in 4 M chaotropic reagent are selected. The polypeptides identified in the additional screen can again be analyzed to identify specific amino acids or patterns of amino acids or other characteristics that confer favorable general biological or biophysical traits and/or desirable specific functional and/or structural properties or levels of activities. For instance, in the first screen an alanine at position 64 may be identified, while in an additional screen the requirement for a N-terminal alpha-helix may be identified. The library can subsequently be redesigned to comprise the amino acids, amino acid patterns or other characteristics that confer a specific type or level of a biological or biophysical trait. Further rounds of screening can be performed to arrive at a library with desired properties. The library can thus be improved iteratively by cycling through multiple rounds of design and screening and/or evaluation. For example, 2-5, 5-10, 10-15, 15-20, or more cycles of assembly, evaluation, and redesign may be performed.

It should be appreciated that the library in each cycle may be enriched for sequence conferring favorable general traits and/or desirable specific properties relative to sequences conferring unfavorable general traits and/or undesirable specific properties. For example, the ratio of favorable general traits and/or desirable specific properties to unfavorable general traits and/or undesirable specific properties may increase by between about 5% and about 50% (e.g., by about 10%) in each cycle. However, it also should be appreciated that the library size (e.g., the number of different polypeptides that are encoded) may not change, or may increase, or may decrease, in each cycle. For example, although pre-screening using known sequence associated properties and predetermined threshold levels as described herein may reduce the number of theoretically possible variants that are to be synthesized, it should be appreciated that large numbers of variants still may be theoretically acceptable. Accordingly, instead of trying to represent all acceptable variants (e.g., based on a conserved scaffold of interest), a first library may include only a subset of variants. The subset may be determined randomly, may be determined based on available information, or may be based on using only one or two representative types of amino acids at sites of possible variation instead of all possible amino acids. For example, a library may be constructed with only one or two representative hydrophobic amino acids, one or two positively charged amino acids, one or two negatively charged amino acid, one or two polar amino acids, one or two non-polar amino acids, one or two small amino acids, one or two bulky amino acids, one or two aromatic amino acids, one or two aliphatic amino acids, etc., or any combination of two or more thereof at each variable position or a subset thereof (e.g., at each position where such variants are acceptable based on pre-screening criteria). As a result, general conclusions may be drawn relating to the favorability/unfavorability and/or desirability/undesirability of different classes of amino acids at certain positions. Based on these conclusion, more, or all, different amino acid variants of a type (e.g., positive, negative, polar, hydrophobic, non-polar, small, bulky, aromatic, aliphatic, etc.) conferring favorable and/or desirable traits or properties may be included at those positions in subsequent libraries. Conversely, fewer, or no, different amino acid variants of a type (e.g., positive, negative, polar, hydrophobic, non-polar, small, bulky, aromatic, aliphatic, etc.) conferring unfavorable and/or undesirable traits or properties may be included at those positions in subsequent libraries.

It also should be appreciated that a library may be designed and/or assembled to not include variants at all positions at which variants are acceptable (e.g., based on an initial scaffold, consensus sequence, and or pre-screening criteria). Positions at which variants are included may be determined randomly or using a systematic approach. For example, an initial library may include variants at positions that are adjacent to (e.g., within 5, 10, 15, or 20 amino acids of) to a cluster of conserved amino acids, a known structural or functional motif (e.g., a binding site, an active site, etc.), within a buried region of the folded protein, within an exposed region of the folded protein, within the N-terminal domain, within the C-terminal domain, within a linker domain, etc., or any combination thereof. In some embodiments, variants may be included in only a subset of possible positions based on a systematic pattern (e.g., every second, third, fourth, fifth, etc., possible variant position). As a result, general conclusions may be drawn relating to the favorability/unfavorability and/or desirability/undesirability of amino acid variation at certain positions. Based on these conclusion, amino acid positions at which variants were found to confer unfavorable and/or undesirable traits or properties may be maintained invariant in subsequent libraries. Conversely, subsequent libraries may include more variant amino acids at positions where variants were found to confer favorable and/or desirable traits or properties. In addition, variants may be tested at positions adjacent to favorable position in subsequent libraries or variants may be excluded from positions adjacent to positions that did not tolerate variation. However, different conclusion may be drawn depending on the screens and types of protein being analyzed. In some embodiments, subsequent libraries also may include variants at positions that were not previously varied.

It should be appreciated that initial variant restricted libraries may be restricted to contain only one or two representative types of amino acids at variant positions and also be restricted to contain variants at only subsets of positions as described above. Also, in some embodiments, several different restricted libraries (e.g., with different representative types of variant amino acids, and/or with variant amino acids at different subsets of positions) may be tested in parallel and the general conclusions from their evaluation may be used for subsequent library design (e.g., for one subsequent library or for a plurality of subsequent libraries that also will be evaluated in parallel).

It should be appreciated that threshold levels of desirable or undesirable traits that may be used for pre-filtering libraries (e.g., solubility etc.) may be determined by a user and may depend on the application and factors such as patient risk, cost of protein, transport requirements, storage requirements, and/or other factors. Accordingly, different threshold levels may be different depending on the application. However, aspects of the invention relate to using a predetermined threshold for a particular application as a basis for prescreening a library of potential sequences in order to avoid making ones that don't meet the criteria for certain applications. It should be appreciated that methods for determining whether or not certain sequences are above or below an acceptable threshold may be used as described herein and adapted for different user applications. Sequences that are predicted to be above or below an acceptable threshold are removed from a theoretical library and not synthesized in a physical library. It also should be appreciated that the properties of certain sequences may not be readily determined using known methods for predicting structural and/or functional traits or properties. In some embodiments, sequences having unknown levels of one or more structural and/or functional traits or properties are included in a library. In some embodiments, undesirable sequences and unknown sequences are excluded and only those predicted to have known acceptable levels of one or more structural and/or functional traits or properties are included in the library. In addition, as described herein, methods involving several cycles of library assembly may be combined with predictive pre-screening methods to inform whether certain variants should be included in later libraries based on structural and/or functional traits or properties of certain sequences (e.g., in the context of an initial scaffold) in an initial or prior library.

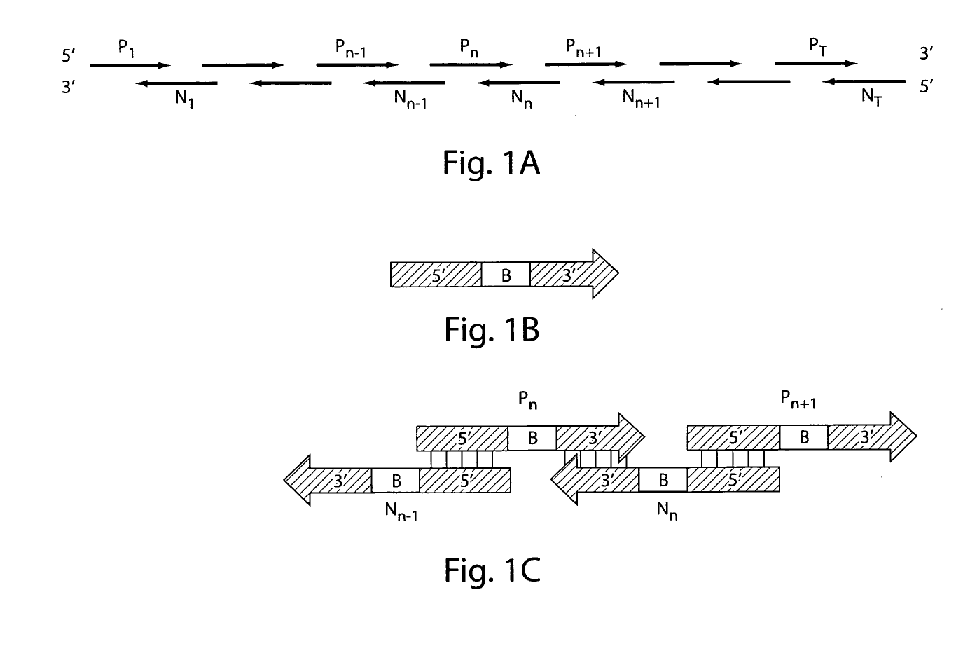

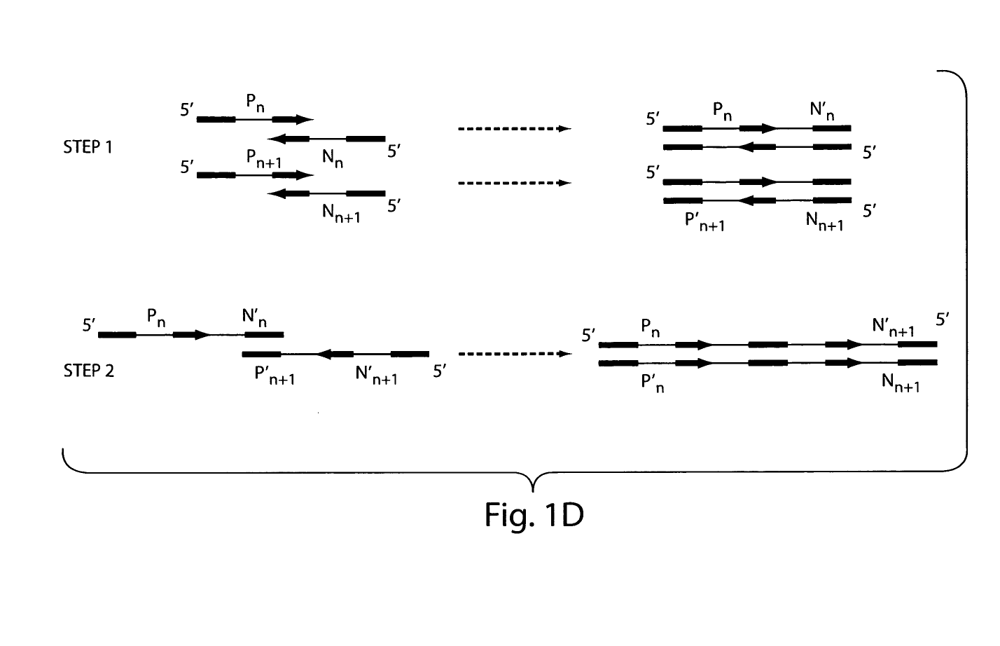

According to aspects of the invention, a library containing a large number of different nucleic acids having defined sequences may be assembled using any suitable in vitro and/or in vivo nucleic acid assembly procedure that allows a plurality of specific sequences to be assembled while excluding other specific sequences. According to aspects of the invention, a library may be assembled in a process that involves assembling a plurality of nucleic acids (e.g., polynucleotides, oligonucleotides, etc.) to form a longer nucleic acid product. A library may contain nucleic acids that include identical (non-variant) regions and regions of sequence variation. Accordingly, certain nucleic acids being assembled may correspond to the non-variant sequence regions. Other nucleic acids being assembled may correspond to one of several predetermined sequence variants in a predetermined region of sequence variation. Non-limiting examples of assembly reactions are described herein and illustrated in FIGS. 1-4. It should be appreciated that one or more of the nucleic acids illustrated in FIGS. 1-4 may be a mixture of nucleic acids that contain one or more identical shared sequence regions, for example the 5′ and 3′ regions that are designed to overlap with adjacent nucleic acids during the assembly procedure, and one or more unique sequence regions, for example one or more regions corresponding to a single predetermined sequence variant. It should be appreciated that aspects of the invention may be automated (e.g., using computer-implemented analyses, assemblies, screens, selections, etc.).

In some embodiments additional screens may select polypeptides for a different trait or property than the initial screen. For instance, the initial screen may identify polypeptides with increased stability while the additional screen may identify polypeptides with decreased immunogenicity, thereby optimizing the library for multiple desired traits. In some embodiments information obtained from initial screens for one or more desired traits can be used to pre-filter a library for a next round of design and, optionally, screening. In some embodiments the library is redesigned after each screen. In some embodiments the library is redesigned after one round of multiple screens for different biological and biophysical traits. For instance, a number of functional screens can be performed to optimize a library for multiple characteristics (e.g. one screen for stability, a second screen for solubility and a third screen for immunogenicity). Polypeptides identified in one or more of the screens can than be analyzed to redesign a library that is optimized for these multiple traits. In some embodiments the library is redesigned and resynthesized after each round of screening for one or multiple characteristics. In some embodiments the library is subjected to multiple rounds of screening before the library is redesigned and resynthesized.

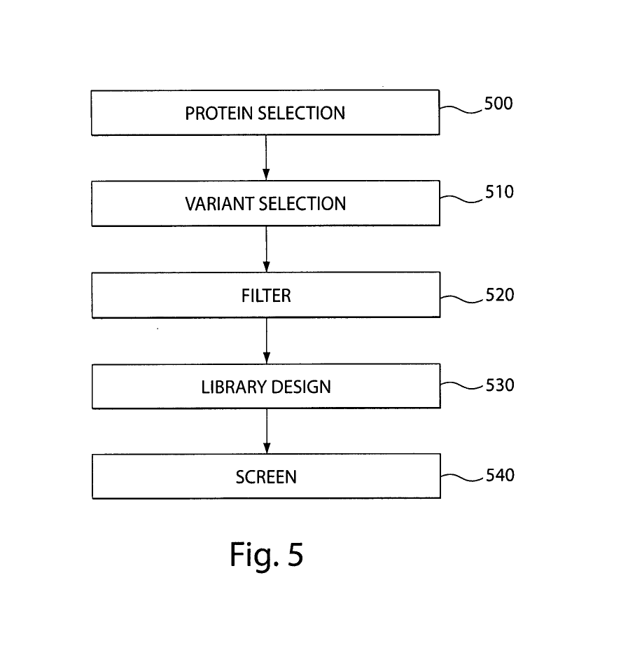

FIG. 5 illustrates one aspect of a process of designing a library that expresses polypeptide variants having predetermined thresholds for one or more biophysical and/or biological traits. Initially, in act 500, a protein that may be used as a scaffold for the library is selected. A scaffold protein will have a selected number or amino acids or functional and/or structural elements that are fixed. For instance, a specific polypeptide scaffold library may have a lysine at position 4 and a DNA binding domain at its N-terminus, but all other positions may be varied during the design, screening and synthesis stages. In act 510, positions at which amino acids may be changed are determined. In some embodiments, a corresponding list of all potential amino acid sequence variants may be identified. This list may be referred to as a theoretical library of polypeptide sequences that can be analyzed and filtered to exclude unwanted sequences in act 520. In act 530, a library is designed and assembled to express all of the filtered polypeptide sequence variants or a fraction thereof. In act 540, a screen, selection, or other analysis is performed to identify one or more polypeptides in the library that have one or more structural or functional properties of interest. It should be appreciated that one or more of these acts may be omitted in certain embodiments of the invention. It also should be appreciated that one or more of these acts may be automated (e.g., computer-implemented).

In act 500, a polypeptide scaffold is selected. A library may be designed to express any type of polypeptide (e.g., linear polypeptides, constrained polypeptides, and variants thereof). A polypeptide scaffold may be based on, but is not limited to, one of the following peptides: cysteine-rich small proteins (e.g., toxins, extracellular domains of receptor proteins, A-domains, etc.), Zinc fingers, immunoglobulin-like domains (including, for example, the tenth human fibronectin type III domain and other fibronectin type III domains), lipocalins, lectin domains (including, for example, C-type lectin domain), ankyrins, human serum proteins (including, for example, human serum albumin), antibodies and antibody fragments (including, for example, single-chain antibodies, Fab fragments, single-domain (VH or VL) antibodies, camel antibody domains, humanized camel antibody domains), antibody regions (including one or more framework regions, one or more constant regions, one or more variable regions, one or more CDR regions), enzymes (including, for example, glucose isomerase, cellulase, hemicellulase, glucoamylase, alpha amylase, subtilisin, lipases, dehydrogenases, etc.), DNA-binding proteins (including, for example, the lac repressor, trp repressor, tet repressor, CAP activator, etc.), cytokines (including, for example, IL-1, IL-4, IL-8, etc.), hormones (including, for example, insulin, growth hormone, etc.), other suitable proteins, or combinations thereof.

General features that are useful for a scaffold polypeptide to have may include one or more of the following non-limiting features: a known structure; high stability and solubility; low immunogenicity; ease of expression in microbial system and ease of purification; a combination of residues that provide a well-defined, stable folded structure, and residues that can be mutated or randomized without destroying the overall fold (such ‘randomizable’ residues may be solvent-exposed or may not be involved in secondary structure or may not pack against other residues in the structure—when comparing sequences of homologous proteins, there is more variation between residues between residues in ‘randomizable’ positions than between residues critical for structure); positions/residues that are known to be associated with a particular structural motif, these could be conserved residues or residues that have been identified by structural analysis or mutagenesis to be important for preserving a structural scaffold; a scaffold of a protein that performs a function related to the desired function; independently folded domains of multi-domain proteins; and/or a monomeric state (associates with no other proteins, or only minimal number of other proteins that will either not be present during application or that are important for the function that is being engineered).

In some embodiments libraries of scaffold polypeptides are polypeptides with a specific biological function. Examples of biological functions are binding, inhibiting a biological process, catalyzing a specific reaction, etc. An example of a library of scaffold polypeptides with a specific biological function are polypeptides that can bind to a linear polypeptide and polypeptides that can bind to a phosphotyrosine.

Scaffolds of polypeptides that bind linear peptides can be based on proteins that are evolved to bind linear polypeptides. These proteins include major histocompatibility complex proteins (MHC I and MHC II), peptide transporter proteins, chaperones, proteases, and multi-domain proteins comprising peptide-binding domains such as poly(A)-binding protein, SH2 domains, SH3 domains, PDZ domains, and WW domains. Major histocompatibility complex proteins display peptides of 9-12 amino acids on the surface of antigen-presenting cells, where the MHC-peptide complex can be recognized and bound by T-cell receptor. Humans have several hundred different MHC alleles, which vary in their specificity and affinity for specific peptides. MHC polypeptide scaffolds are designed based on the analysis of theses alleles. Peptide transporter proteins bind to linear peptides of 2-18 amino-acid residues, and bury at least a part of the peptide in their core. The transporter-peptide complex can subsequently be translocated across the membrane with the help of additional transport complex components. One example of a peptide transporter is the oligopeptide permease (Opp) family, with different members of the family recognizing peptides of different lengths and sequences with nanomolar to micromolar affinity. One member of the family, the Opp protein of Lactococcus lactis (OppALl) can bind and transport peptides of up to 18 residues and longer. Polypeptide scaffolds are designed based on the analysis of the peptide binding properties, including the core region, of OppAl1 and other peptide transport proteins. Proteases cleave polypeptides, and differ widely by their degree of substrate specificity. Inactive mutants have been constructed that bind polypeptides, but do not cleave them. These mutant proteases are therefore particularly suited as scaffold polypeptides for polypeptides with peptide binding properties. The poly(A)-binding protein (PABC) has a C-terminal domain of interacts with translational factors in a random-coil configuration. The peptide motif that binds to PABC comprises 12-15 amino-acid residues and is in a formation resembling random-coil when bound to PABC. The peptide binding domain of PABC of various species can be analyzed to identify residues essential to peptide binding. Scaffold polypeptide for libraries of peptide binding polypeptides are designed based on these principles.

Scaffolds of polypeptides that bind phosphotyrosines can be based on proteins that are evolved to bind and/or process phosphotyrosines. Phosphotyrosine binding and processing proteins include proteins with phosphotyrosine-binding (PTB) domains, protein tyrosine phosphatases (PTPs), and mitogen-activated protein kinase (MAPK) phosphatases (MKPs). Phosphotyrosine-binding (PTB) domains are naturally occurring phosphotyrosine binding modules. The protein structure generally falls under the pleckstrin homology (PH) superfold. The peptides are recognized in general according to the motif N—P—X-(phospho Y/Y/F) whit the peptide binding as a type I beta turn. Examples of mammalian PTBs include Shc, Sck, X11, Doc-2, and p96, while drosophila PTBs include Dab and Numb. There are at least 50 PTB domains known from at least 46 proteins, with many structures elucidated by NMR or crystal structures, for instance Shc, X11, IRS-1, Talin, Dab1/2, Numb, SNT, Dok1/5, Radixin, and tensin1. Proteins with PTBs are analyzed to design a scaffold polypeptide for phosphotyrsosine binding. Extra weight will be given to proteins that bind phosphotyrosine peptides in a phosphotyrosine dependent manner. Examples of such proteins include Shc-like PTBs, and IRS-like PTBs (which include IRS, Dok, and SNT) and proteins including the C2 domain of PKCδ and possibly PKCθ. Protein tyrosine phosphatases (PTPs) often play a critical role in cellular regulation by dephosphorylating tyrosines of signaling molecules. PTPs include both receptor-like PTPs and non-transmembrane PTPs. Some examples of PTPs are SHP-2 (PTPN11), PTP-1B (PTPN1), TCPTP (PTPN2), PEP (PTPN22), SHP-1 (PTPN6), PTP-PEST (PTPN12), PTP-MEG2 (PTPN9), STEP (PTPN5), and HePTP (PTPN7). While PTPs process phopshotyrosine peptides, the phosphatase activity can be inactivated resulting in a polypeptide that can bind phosphotyrosines but can not process them. The PTP active site generally contains the motif HC(X₅)R, and may additionally contain a WPD motif. The dephosphorylation function can be inactivated by introducing one or more mutations in the active-site. For example, the essential C and/or R (such as C—S), and/or the invariant D (such as D-A), or combinations thereof (such as C—S/D-A or D-A/Q-A) can be mutated to result in an inactive phosphatase activity. Scaffold polypeptides are designed based on these inactivated PTPs. Mitogen-activated protein kinase (MAPK) phosphatases (MKPs) are related to PTPs and can dephosphorylate both phosphothreonine and phosphotyrosine residues. MPKs are found in various mammalian pathways, including ERK, JNK (MAPK8), p38 (MAPK14). The active site of these proteins is mutated to result in a polypeptide scaffold and this polypeptide scaffold san subsequently be used as a scaffold for a library of phosphotyrosine binding polypeptides.

However, in some embodiments, a library may be designed to express random polypeptides that are not based on any defined structural scaffold.

In act 510, residues that may be changed in the library may be identified.

General features that may be used for selecting one or more residues to be varied in the library may include one or more of the following non-limiting features: residues in a binding domain (for example a receptor binding domain, a ligand binding domain or a substrate binding domain), in particular residues in contact with, or adjacent to a bound ligand; residues in a catalytic domain, in particular residues in, or immediately adjacent to, an active site; adjacent residues, for example residues that on the surface of a protein that may be modified to make an artificial antibody; surface residues; buried residues, for example proteins can be stabilized by re-engineering their core; residues that are thought to, or known to, tolerate changes without affecting the structure of the scaffold; residues that vary between homologous proteins; and/or residues that have been shown to affect function.

If there is a long list of residues that can be changed, a hierarchy to select the preferred subset to be altered may be established. The hierarchy depends on the application. One potential hierarchy is the following:

1) avoid destabilization of the protein;

2) for therapeutic proteins, minimize the number of residues to be randomized in order to minimize the risk of immunogenicity;

3) provide a large enough variability in the shape of a possible target-binding surface or in the chemistry of a catalytic active site to maximize the chance of selecting a variant with new function;

4) limit the number of randomized positions to positions that may affect each other; aim to sample every possible permutation of residue on those positions; and

5) limit the number and nature of replacements at each position based on their predicted effect on the function.

Once positions to be varied are identified, a theoretical library may be determined that includes all combinations of possible amino acid variants at those positions. In some embodiments, all natural amino acid variants are considered (e.g., the 20 amino acids that are present in most natural proteins or polypeptides). In some embodiments, non-natural amino acids also may be considered. However, in some embodiments a first library may be designed to include a subset of variants.

In act 520, the theoretical library may be filtered to identify and/or exclude sequence variants that are known or expected to confer one or more unwanted traits. One or more filtering steps may be implemented to identify and/or exclude one or more different traits that may be unwanted. Filtering may be based on predicted properties of amino acid sequences, known properties of amino acid sequences, or combinations thereof. It should be appreciated that the trait(s) selected to be excluded may depend on the application that is being screened for. For example different types of predictions may be relevant to different applications. In some embodiments, library filtering based on predicted immunogenicity would be irrelevant if the library is to be screened for better industrial enzymes. In some embodiments, the largest number of filters that are relevant for a particular application may be incorporated in filtering act 520.

Filter parameters that may be useful to select sequence variants that are known or expected to confer one or more unwanted traits may include one or more of the following non-limiting parameters: a) immunogenicity (T-cell epitopes may be removed—algorithms for predicting T-cell epitopes may be used—other known or predicted epitopes also may be removed—non-limiting examples for reducing the immunogenicity of a protein are reported in US Patent Publications US20060025573 and US20040082039, the disclosures of which are hereby incorporated by reference); b) other immunogenicity-related properties, including aggregation, binding to receptors on antigen-presenting cells, proteosome cleavage, transport of cleavage product by TAP, the transporter associated with antigen processing; c) other factors that determine immunogenicity including factors reported in US Patent Publications US20040203100, US20060073563, US 20060014248, US20050079183 and US20050214857; U.S. Pat. No. 6,929,939 and WO2003104803, the disclosures of which are hereby incorporated by reference; d) solubility; for instance including calculating the predicted pI of a sequence and excluding the sequence if the pI is within 0.5 pH units, within 1 pH unit, within 2 pH units, within 3 pH units, within 4 pH units, or within 5 pH units, of the pH at which the polypeptide may be expressed, purified, stored and/or used; e) stability; for instance including structure based methods, molecular modeling methods and other computer based methods (see e.g. US Patent Publications US20060073563 and US20060014248); f) the presence of sequences that are undesirable, for instance including protease sensitive sequences, toxic sequences and sequences that are known to interact with unwanted targets; g) the exclusion of Cys residues that are not close enough to form disulfide bonds in a folded structure based on the known structure of the scaffold; h) the exclusion of excessive numbers of Trp residues, in some embodiments 2, 3, 4, or more Trp residues can be excluded; and i) the exclusion of chemically active sequences of amino acids, for instance asparagine and glutamine deamidate more readily when followed by a glycine.

Accordingly, a final library of filtered peptide products to be synthesized may be determined. It should be appreciated that different filtering parameters may be varied in order to increase or decrease the stringency of the filtering process.

In some embodiments, a filtering process may proceed according to the following steps. First, a list of more than 100 related protein sequences may be generated based on available information of a scaffold structure and function. Second, each sequence may be subjected to an automatic calculation to evaluate the property of choice; sequences with values below the cutoff will be eliminated from the list. This step may be repeated for each property under examination. Third, selected protein sequences may be reverse-transcribed into DNA sequences. Each DNA sequence may be optimized for codon usage, secondary structure formation, presence of restriction sites, etc., without changing the protein sequence. Optimized DNA sequences on the list then may be assembled using any appropriate assembly method.

To validate the improvement of properties due to a pre-filtering strategy, parallel DNA libraries may be generated initially with and without the theoretical pre-filtering step. Randomly selected members of pre-filtered and unfiltered libraries may then be translated into protein and tested for the property under investigation. In addition, in-vitro selections may be performed under identical conditions for pre-filtered and unfiltered libraries, and the properties of the selected proteins from each may be compared.

In some embodiments, libraries may be filtered for high solubility. For example, a simple method of predicting protein solubility based on its sequence is through the calculation of its isoelectric point (pI), the pH where the protein has no net charge. Numerous well-established algorithms are available for calculating the pH of a given sequence (e.g., http://www.scripps.edu/˜cdputnam/protcalc.html, http://www.embl-heidelberg.de/cgi/pi-wrapper.pl). In some embodiments, a protein is predicted to be soluble if its pH is significantly higher or lower than the pH (e.g., by 0.5 pH units or more) of the buffer employed to purify and/or use the protein.

Other possible measures of solubility include overall hydrophobicity of the protein, which can be either the proportion of amino-acid residues in the protein that are apolar, or the proportion of residues predicted to be accessible to the solvent that are apolar. Alternatively, only the number of tryptophan residues can be limited, or cysteine residues can be prohibited from randomized positions.

In some embodiments, representative members of libraries and selected proteins can be evaluated for solubility by comparing their expression level, the concentration beyond which they aggregate, or the proportion of protein sample at a set concentration that aggregates when incubated at a set temperature.

In some embodiments, libraries may be filtered for low immunogenicity. The immunogenicity of a protein can be predicted computationally by breaking down the protein into a series of overlapping peptides, then evaluating the fit of each resulting peptide to the peptide-binding site of an MHC type II molecule (Chirino et al, Drug Discovery Today (2004), 83; e.g., Jones et al (2004), J. Interferon Cytokine Res 24, 560). In certain embodiments, peptide sequences can be compared to databases of peptide sequences known to bind such MHC II molecules, or known to stimulate T-cells (Novozymes).

Representative members of libraries and selected proteins can be evaluated for immunogenicity by expressing and purifying each protein in a microbial system, then testing their ability to stimulate T-cells from diverse human donors. Individual peptides that make up the protein or pools of such peptides can also be tested for their ability to stimulate T-cells. In some embodiments, proteins can be evaluated by injecting them into transgenic mice that express the human version of the scaffold the proteins are based on.

In some embodiments, libraries may be filtered for high stability. In some embodiments, in order to predict the stability of each protein, its three-dimensional structure can be simulated computationally and evaluated for favorable and unfavorable interactions (Chirino et al, Drug Discovery Today (2004), 83; e.g., Luo et al (2002) Protein Sci. 11, 1218). In certain embodiments, the simulated structure could be compared to the known structure of the scaffold it is based on, or to known structures of proteins that are homologous to the scaffold. In some embodiments, structures that are more similar to existing protein structures are predicted to be more stable. In some embodiments, the effect of a mutation on scaffold stability can be studied experimentally before embarking on library construction. For example, each position in the scaffold can be separately mutated to all possible amino acids, and the resulting mutant proteins can be expressed and evaluated for stability, solubility, or both. Libraries based on that scaffold can then be designed to avoid mutations that have been shown to destabilize the scaffold.

Representative members of libraries and selected proteins can be evaluated for stability by comparing their expression level, melting temperature, concentration of urea or guanidine required to denature them, or the proportion of each protein sample at a set concentration that aggregates when incubated at an elevated temperature.

In act 530, a library of filtered sequences may be obtained (e.g., assembled as described herein). The library may be cloned into any suitable vector (e.g., any suitable expression vector) in any suitable organism. Any suitable vector may be used, as the invention is not so limited. For example, a vector may be a plasmid, a bacterial vector, a viral vector, a phage vector, an insect vector, a yeast vector, a mammalian vector, a BAC, a YAC, or any other suitable vector. In some embodiments, a vector may be a vector that replicates in only one type of organism (e.g., bacterial, yeast, insect, mammalian, etc.) or in only one species of organism. Some vectors may have a broad host range. Some vectors may have different functional sequences (e.g., origins or replication, selectable markers, etc.) that are functional in different organisms. These may be used to shuttle the vector (and any nucleic acid fragment(s) that are cloned into the vector) between two different types of organism (e.g., between bacteria and mammals, yeast and mammals, etc.). In some embodiments, the type of vector that is used may be determined by the type of host cell that is chosen.

It should be appreciated that a vector may encode a detectable marker such as a selectable marker (e.g., antibiotic resistance, etc.) so that transformed cells can be selectively grown and the vector can be isolated and any insert can be characterized to determine whether it contains the desired assembled nucleic acid. The insert may be characterized using any suitable technique (e.g., size analysis, restriction fragment analysis, sequencing, etc.). In some embodiments, the presence of a correctly assembly nucleic acid in a vector may be assayed by determining whether a function predicted to be encoded by the correctly assembled nucleic acid is expressed in the host cell.

In some embodiments, host cells that harbor a vector containing a nucleic acid insert may be selected for or enriched by using one or more additional detectable or selectable markers that are only functional if a correct (e.g., designed) terminal nucleic acid fragments is cloned into the vector.

Accordingly, a host cell should have an appropriate phenotype to allow selection for one or more drug resistance markers encoded on a vector (or to allow detection of one or more detectable markers encoded on a vector). However, any suitable host cell type may be used (e.g., prokaryotic, eukaryotic, bacterial, yeast, insect, mammalian, etc.). In some embodiments, the type of host cell may be determined by the type of vector that is chosen. A host cell may be modified to have increased activity of one or more ligation and/or recombination functions. In some embodiments, a host cell may be selected on the basis of a high ligation and/or recombination activity. In some embodiments, a host cell may be modified to express (e.g., from the genome or a plasmid expression system) one or more ligase and/or recombinase enzymes.

In act 540, proteins expressed by the filtered library may be screened or selected for one or more functions or structures of interest. It should be appreciated that expression libraries of the invention may be nucleic-acid/polypeptide libraries in which each nucleic acid molecule is physically associated with the polypeptide it encodes. In some embodiments, an expression library may be a screening library. An example of a screening library may be one where the physical association between the nucleic acid and the encoded polypeptide is provided by a well (e.g., in a 96-well plate). In some embodiments, an expression library may be a display library. Examples of display libraries include those generated by phage, bacterial, yeast, mRNA, or ribosome display, where each nucleic acid and corresponding polypeptide are part of the same physical particle (e.g., a bacteriophage, a bacterium, a yeast cell, covalent mRNA-polypeptide fusion, or non-covalent mRNA/ribosome/polypeptide complex).

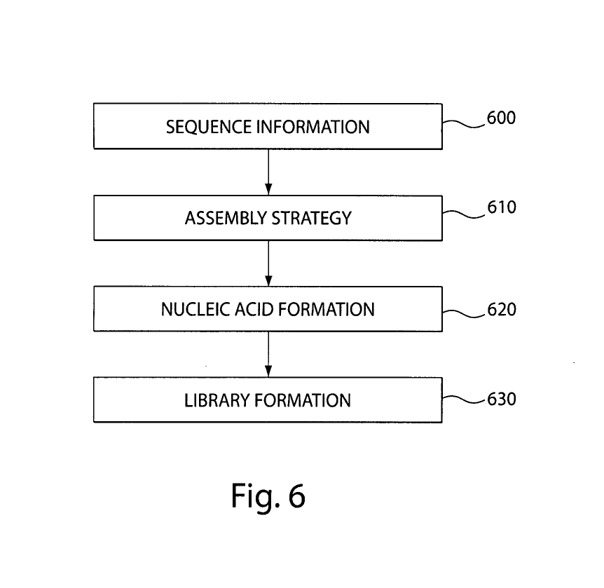

It should be appreciated that preferred methods of assembling a nucleic acid library are methods that can be used to effectively assemble a large number of defined sequence variants at predetermined positions of interest while specifically excluding other sequence variants at those positions. FIG. 6 illustrates an embodiment of a library assembly process of the invention. In act 600, sequence information is obtained defining the sequences that are to be included in the library. In act 610, an assembly strategy is formulated. In act 620, starting nucleic acids are obtained. In act 630, the starting nucleic acids are assembled to form the library. In some embodiments, the library may be used to screen or select for polypeptides having one or more properties of interest. In some embodiments, the library may be sent or shipped to a customer. In some embodiments, the library may be stored and used to generate a nucleic acid sequence library that contains a plurality of predetermined sequence variants. It should be appreciated that one or more of these acts may be omitted in certain embodiments of the invention. It should be appreciated that one or more of these acts may be automated (e.g., computer-implemented).

Initially, in act 600, information defining the specific nucleic acid sequences to be included in the library may be obtained from any source. In some embodiments, nucleic acid sequence variants to be included in a library may be those that encode polypeptide sequences that were identified in a filtering process of the invention. In some embodiments, a list of different polypeptide variants to be encoded by a library may be designed or obtained (e.g., in the form of a customer order or request). The different nucleic acid sequences to be assembled may be determined based on the identity of the polypeptide sequences to be included in a library. It should be appreciated that different nucleic acid sequences may encode the same polypeptide due to the degeneracy of the genetic code. In some embodiments, the sequence of a nucleic acid selected to code for a defined polypeptide variant may be determined based on any suitable parameter, including, for example, the codon bias in the host organism used for the library, the synthesis strategy, the relative ease of assembling certain sequences (e.g., sequences may be selected to avoid direct or inverted sequence repeats, sequences that stabilize one or more secondary structures, sequences with high GC or AT content, etc.), or any combination thereof. For example, when choosing codons for each amino acid, consideration may be given to one or more of the following factors: i) using codons that correspond to the codon bias in the organism in which the target nucleic acid may be expressed, ii) avoiding excessively high or low GC or AT contents in the target nucleic acid (for example, above 60% or below 40%; e.g., greater than 65%, 70%, 75%, 80%, 85%, or 90%; or less than 35%, 30%, 25%, 20%, 15%, or 10%), iii) avoiding sequence features that may interfere with the assembly procedure (e.g., the presence of repeat sequences or stem loop structures), and iv) using codons for each amino acid such that the expression levels of some or all of the proteins in the library are normalized, for example if some desired sequences are anticipated to express less than others, it may be desirable to purposely decrease the expression level of the others, so expression bias does not affect the assay result. However, these factors may be ignored in some embodiments as the invention is not limited in this respect. In some embodiments, a customer order may include a specific list of defined nucleic acid sequences to be included in a library (e.g., for a library of defined DNA sequences, a library designed to express defined RNA sequences, etc.). A polypeptide or nucleic sequence order from a customer may be received in any suitable form (e.g., electronically, on a paper copy, etc.).

In act 610, the sequence information may be analyzed to determine an assembly strategy. This may involve determining whether the library may be assembled in a single reaction or if several intermediate fragments may be assembled separately and then combined in one or more additional rounds of assembly to generate the target nucleic acid library. Once the overall assembly strategy has been determined, input nucleic acids (e.g., oligonucleotides) for assembling the one or more nucleic acid fragments may be designed. The sizes and numbers of the input nucleic acids may be based in part on the type of assembly reaction (e.g., the type of polymerase-based assembly, ligase-based assembly, chemical assembly, or combination thereof) that is being used for each fragment. The input nucleic acids also may be designed to avoid 5′ and/or 3′ regions that may cross-react incorrectly and be assembled to produce undesired nucleic acid fragments. Other structural and/or sequence factors also may be considered when designing the input nucleic acids. In certain embodiments, some of the input nucleic acids may be designed to incorporate one or more specific sequences (e.g., primer binding sequences, restriction enzyme sites, etc.) at one or both ends of the assembled nucleic acid fragment. In other embodiments these specific sequences may be at positions within the nucleic acid fragment.

In some embodiments, information developed during the design phase may be used to determine an appropriate synthesis strategy for certain variants. For example, it may be apparent from the sequence analysis and the assembly design that certain sequences may be poorly assembled and therefore under-represented in an assembled library. In some embodiments, these sequences may be assembled separately. In some embodiments, certain sequences may be identified for a user (e.g., a customer) as likely to be under-represented in a library or absent from the library.

In some embodiments, certain input nucleic acids may include one or more variant regions that encode one of several different predetermined amino acid sequences that are part of the library. In some embodiments, an input nucleic acid may be designed to restrict the variant sequences to a central region of the nucleic acid that does not overlap with adjacent 5′ and 3′ regions.

In act 620, input nucleic acids are obtained. These may be synthetic oligonucleotides that are synthesized on-site or obtained from a different site (e.g., from a commercial supplier). In some embodiments, one or more input nucleic acids may be amplification products (e.g., PCR products), restriction fragments, or other suitable nucleic acid molecules. Synthetic oligonucleotides may be synthesized using any appropriate technique as described in more detail herein. It should be appreciated that synthetic oligonucleotides often have sequence errors. Accordingly, oligonucleotide preparations may be selected or screened to remove error-containing molecules as described in more detail herein. In one embodiment oligonucleotides will be synthesized as mixtures by using random nucleotide incorporation. The oligonucleotides can later be screened for the correct sequence.

In act 630, an assembly reaction may be performed to produce a library based on the nucleic acids obtained in act 620.

In one embodiment the sequence variability designed for a library is encoded within the size of a single assembly oligonucleotide.

If sequence variability is desired in several different regions of the polypeptide, variant regions may be required in several of the different assembled oligonucleotides. In some embodiments several parallel assembly reactions may be performed to create different subsets of the desired sequences. In some embodiments the oligonucleotides may be pre-screened prior to assembly.

For each fragment, the input nucleic acids may be assembled using any appropriate assembly technique (e.g., a polymerase-based assembly, a ligase-based assembly, a chemical assembly, or any other multiplex nucleic acid assembly technique, or any combination thereof). An assembly reaction may result in the assembly of a number of different nucleic acid products in addition to the predetermined nucleic acid fragment. Accordingly, in some embodiments, an assembly reaction may be processed to remove incorrectly assembled nucleic acids (e.g., by size fractionation) and/or to enrich correctly assembled nucleic acids (e.g., by amplification, optionally followed by size fractionation). In some embodiments, correctly assembled nucleic acids may be amplified (e.g., in a PCR reaction) using primers that bind to the ends of the predetermined nucleic acid fragment. It should be appreciated that act 630 may be repeated one or more times. For example, in a first round of assembly a first plurality of input nucleic acids (e.g., oligonucleotides) may be assembled to generate a first nucleic acid fragment. In a second round of assembly, the first nucleic acid fragment may be combined with one or more additional nucleic acid fragments and used as starting material for the assembly of a larger nucleic acid fragment. In a third round of assembly, this larger fragment may be combined with yet further nucleic acids and used as starting material for the assembly of yet a larger nucleic acid. This procedure may be repeated as many times as needed for the synthesis of a target nucleic acid. Accordingly, progressively larger nucleic acids may be assembled. At each stage, nucleic acids of different sizes may be combined. At each stage, the nucleic acids being combined may have been previously assembled in a multiplex assembly reaction. However, at each stage, one or more nucleic acids being combined may have been obtained from different sources (e.g., PCR amplification of genomic DNA or cDNA, restriction digestion of a plasmid or genomic DNA, or any other suitable source).

It should be appreciated that nucleic acids generated in each cycle of assembly may contain sequence errors if they incorporated one or more input nucleic acids with sequence error(s). At some stage during the library assembly process, fidelity optimization can be performed. In one embodiment this is done by MutS. In some embodiments, variant fragments are created and processed by MutS separately. In some embodiments the variant regions of the library are evaluated by sequencing.

In certain embodiments, constant portions of a protein scaffold may be synthesized and error-corrected. In contrast, variant positions may be assembled without error correction. In some embodiments, the presence of a background of additional sequence variants may not interfere with the library as a whole if the number of unwanted sequence errors is low relative to the number of predetermined sequence variants in the library. However, in some embodiments the presence of errors within the constant regions of the scaffold may be undesirable if these sequence errors have a negative impact on the function of the predetermined sequence variants that they are associated with.

In some embodiments, assembly reactions may be performed using assembly nucleic acids that have not been amplified (e.g., assembly oligonucleotides that were synthesized and released from an array without an amplification step). In some embodiments, a plurality of non-amplified overlapping nucleic acids may be assembled to generate one variant sequence for a library. This variant fragment may be amplified. In some embodiments, this variant fragment may be amplified using one or more universal primers if the flanking assembly nucleic acids have sequences (e.g., sequences that may need to be removed) that are complementary to the universal primers.

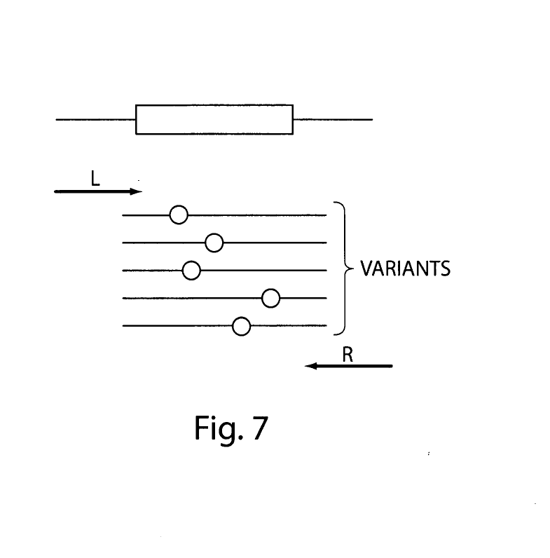

FIG. 7 illustrates an embodiment where the variant region is approximately the size of an assembly nucleic acid (e.g., an assembly oligonucleotide). In some embodiments, assembly nucleic acids designed to correspond to the same region of a target nucleic acid are designed to contain sequence variants only within their central region. These variant encoding assembly nucleic acids can be amplified by using one or more primers that bind to the non-variant 5′ and 3′ regions. Accordingly, a plurality of assembly nucleic acids (e.g., a plurality of different assembly oligonucleotides synthesized on an array), each encoding a different variant sequence, can be amplified using the same 5′ and 3′ primers (e.g., shown as L and R in FIG. 7). Accordingly, in some embodiments, these variant-encoding assembly nucleic acids are synthesized without any flanking 3′ and/or 5′ amplification sequences (e.g., without any sequences that correspond to universal primer sequences). These assembly nucleic acids can be amplified and used for assembly without removing flanking amplification regions. However, in some embodiments these variant-encoding assembly nucleic acids are not amplified and are used directly in an assembly reaction (e.g., after release from a solid support such a synthesis array). Accordingly, L and R in FIG. 7 may be adjacent assembly nucleic acids such as adjacent oligonucleotides in the assembly reaction. It should be appreciated that these adjacent oligonucleotides also may be used prior to amplification. In some embodiments, the variant-encoding assembly nucleic acids shown in FIG. 7 are designed to span a region between a 5′ fragment of a gene and a 3′ fragment of the same gene. The 5′ and 3′ fragments may be prepared using any suitable technique (e.g., by amplification, restriction enzyme cloning, etc.). Accordingly, L and R in FIG. 7 may be the 5′ and 3′ gene fragments in some embodiments. The 5′ and 3′ fragments and the variant-encoding assembly nucleic acids may be designed to include a first region of sequence overlap between the 3′ end of the 5′ fragment and the 5′ end of the assembly nucleic acids and a second region of sequence overlap between the 3′ end of the assembly nucleic acids and the 5′ end of the 3′ fragment (as illustrated in FIG. 7). Accordingly, the variant-encoding assembly nucleic acids (e.g., non-amplified) may be mixed with the 5′ and 3′ gene fragments and assembled in a polymerase-based or a ligase-based extension reaction.

Libraries the invention can be used in any method for in-vitro protein evolution, screening, or selection.

In some embodiments, a recombinase (e.g., RecA) or nucleic acid binding protein may be used to increase the fidelity of one or more assembly reactions. In some embodiments, a heat stable RecA protein may be included in one or more reagents or steps of a multiplex nucleic acid assembly reaction. A heat stable RecA protein is disclosed, for example, in Shigemori et al., 2005, Nucleic Acids Research, Vol. 33, No. 14, e126. Heat stable RecA proteins may be from one or more thermophilic organisms (e.g., Thermus thermophilus or other thermophilic organisms). Heat stable RecA proteins also may be isolated as sequence variants of one or more heat sensitive RecA proteins.

Aspects of the invention may include automating one or more acts described herein. For example, an analysis may be automated in order to generate an output automatically. Acts of the invention may be automated using, for example, a computer system.

Aspects of the invention may be used in conjunction with any suitable multiplex nucleic acid assembly procedure involving at least two nucleic acids with complementary regions (e.g., at least one pair of nucleic acids that have complementary 3′ regions). For example, library assembly may involve one or more of the multiplex nucleic acid assembly procedures described below.

Multiplex Nucleic Acid Assembly

In aspects of the invention, multiplex nucleic acid assembly relates to the assembly of a plurality of nucleic acids to generate a longer nucleic acid product. In one aspect, multiplex oligonucleotide assembly relates to the assembly of a plurality of oligonucleotides to generate a longer nucleic acid molecule. However, it should be appreciated that other nucleic acids (e.g., single or double-stranded nucleic acid degradation products, restriction fragments, amplification products, naturally occurring small nucleic acids, other polynucleotides, etc.) may be assembled or included in a multiplex assembly reaction (e.g., along with one or more oligonucleotides) in order to generate an assembled nucleic acid molecule that is longer than any of the single starting nucleic acids (e.g., oligonucleotides) that were added to the assembly reaction. In certain embodiments, one or more nucleic acid fragments that each were assembled in separate multiplex assembly reactions (e.g., separate multiplex oligonucleotide assembly reactions) may be combined and assembled to form a further nucleic acid that is longer than any of the input nucleic acid fragments. In certain embodiments, one or more nucleic acid fragments that each were assembled in separate multiplex assembly reactions (e.g., separate multiplex oligonucleotide assembly reactions) may be combined with one or more additional nucleic acids (e.g., single or double-stranded nucleic acid degradation products, restriction fragments, amplification products, naturally occurring small nucleic acids, other polynucleotides, etc.) and assembled to form a further nucleic acid that is longer than any of the input nucleic acids.

In aspects of the invention, one or more multiplex assembly reactions may be used to generate target nucleic acids having predetermined sequences. In one aspect, a target nucleic acid may have a sequence of a naturally occurring gene and/or other naturally occurring nucleic acid (e.g., a naturally occurring coding sequence, regulatory sequence, non-coding sequence, chromosomal structural sequence such as a telomere or centromere sequence, etc., any fragment thereof or any combination of two or more thereof). In another aspect, a target nucleic acid may have a sequence that is not naturally-occurring. In one embodiment, a target nucleic acid may be designed to have a sequence that differs from a natural sequence at one or more positions. In other embodiments, a target nucleic acid may be designed to have an entirely novel sequence. However, it should be appreciated that target nucleic acids may include one or more naturally occurring sequences, non-naturally occurring sequences, or combinations thereof.

In one aspect of the invention, multiplex assembly may be used to generate libraries of nucleic acids having different sequences. In some embodiments, a library may contain nucleic acids having random sequences. In certain embodiments, a predetermined target nucleic acid may be designed and assembled to include one or more random sequences at one or more predetermined positions.

In certain embodiments, a target nucleic acid may include a functional sequence (e.g., a protein binding sequence, a regulatory sequence, a sequence encoding a functional protein, etc., or any combination thereof). However, some embodiments of a target nucleic acid may lack a specific functional sequence (e.g., a target nucleic acid may include only non-functional fragments or variants of a protein binding sequence, regulatory sequence, or protein encoding sequence, or any other non-functional naturally-occurring or synthetic sequence, or any non-functional combination thereof). Certain target nucleic acids may include both functional and non-functional sequences. These and other aspects of target nucleic acids and their uses are described in more detail herein.

A target nucleic acid may be assembled in a single multiplex assembly reaction (e.g., a single oligonucleotide assembly reaction). However, a target nucleic acid also may be assembled from a plurality of nucleic acid fragments, each of which may have been generated in a separate multiplex oligonucleotide assembly reaction. It should be appreciated that one or more nucleic acid fragments generated via multiplex oligonucleotide assembly also may be combined with one or more nucleic acid molecules obtained from another source (e.g., a restriction fragment, a nucleic acid amplification product, etc.) to form a target nucleic acid. In some embodiments, a target nucleic acid that is assembled in a first reaction may be used as an input nucleic acid fragment for a subsequent assembly reaction to produce a larger target nucleic acid.

Accordingly, different strategies may be used to produce a target nucleic acid having a predetermined sequence. For example, different starting nucleic acids (e.g., different sets of predetermined nucleic acids) may be assembled to produce the same predetermined target nucleic acid sequence. Also, predetermined nucleic acid fragments may be assembled using one or more different in vitro and/or in vivo techniques. For example, nucleic acids (e.g., overlapping nucleic acid fragments) may be assembled in an in vitro reaction using an enzyme (e.g., a ligase and/or a polymerase) or a chemical reaction (e.g., a chemical ligation) or in vivo (e.g., assembled in a host cell after transfection into the host cell), or a combination thereof. Similarly, each nucleic acid fragment that is used to make a target nucleic acid may be assembled from different sets of oligonucleotides. Also, a nucleic acid fragment may be assembled using an in vitro or an in vivo technique (e.g., an in vitro or in vivo polymerase, recombinase, and/or ligase based assembly process). In addition, different in vitro assembly reactions may be used to produce a nucleic acid fragment. For example, an in vitro oligonucleotide assembly reaction may involve one or more polymerases, ligases, other suitable enzymes, chemical reactions, or any combination thereof.

Multiplex Oligonucleotide Assembly

A predetermined nucleic acid fragment may be assembled from a plurality of different starting nucleic acids (e.g., oligonucleotides) in a multiplex assembly reaction (e.g., a multiplex enzyme-mediated reaction, a multiplex chemical assembly reaction, or a combination thereof). Certain aspects of multiplex nucleic acid assembly reactions are illustrated by the following description of certain embodiments of multiplex oligonucleotide assembly reactions. It should be appreciated that the description of the assembly reactions in the context of oligonucleotides is not intended to be limiting. The assembly reactions described herein may be performed using starting nucleic acids obtained from one or more different sources (e.g., synthetic or natural polynucleotides, nucleic acid amplification products, nucleic acid degradation products, oligonucleotides, etc.). The starting nucleic acids may be referred to as assembly nucleic acids (e.g., assembly oligonucleotides). As used herein, an assembly nucleic acid has a sequence that is designed to be incorporated into the nucleic acid product generated during the assembly process. However, it should be appreciated that the description of the assembly reactions in the context of single-stranded nucleic acids is not intended to be limiting. In some embodiments, one or more of the starting nucleic acids illustrated in the figures and described herein may be provided as double stranded nucleic acids. Accordingly, it should be appreciated that where the figures and description illustrate the assembly of single-stranded nucleic acids, the presence of one or more complementary nucleic acids is contemplated. Accordingly, one or more double-stranded complementary nucleic acids may be included in a reaction that is described herein in the context of a single-stranded assembly nucleic acid. However, in some embodiments the presence of one or more complementary nucleic acids may interfere with an assembly reaction by competing for hybridization with one of the input assembly nucleic acids. Accordingly, in some embodiments an assembly reaction may involve only single-stranded assembly nucleic acids (i.e., the assembly nucleic acids may be provided in a single-stranded form without their complementary strand) as described or illustrated herein. However, in certain embodiments the presence of one or more complementary nucleic acids may have no or little effect on the assembly reaction. In some embodiments, complementary nucleic acid(s) may be incorporated during one or more steps of an assembly. In yet further embodiments, assembly nucleic acids and their complementary strands may be assembled under the same assembly conditions via parallel assembly reactions in the same reaction mixture. In certain embodiments, a nucleic acid product resulting from the assembly of a plurality of starting nucleic acids may be identical to the nucleic acid product that results from the assembly of nucleic acids that are complementary to the starting nucleic acids (e.g., in some embodiments where the assembly steps result in the production of a double-stranded nucleic acid product). As used herein, an oligonucleotide may be a nucleic acid molecule comprising at least two covalently bonded nucleotide residues. In some embodiments, an oligonucleotide may be between 10 and 1,000 nucleotides long. For example, an oligonucleotide may be between 10 and 500 nucleotides long, or between 500 and 1,000 nucleotides long. In some embodiments, an oligonucleotide may be between about 20 and about 100 nucleotides long (e.g., from about 30 to 90, 40 to 85, 50 to 80, 60 to 75, or about 65 or about 70 nucleotides long), between about 100 and about 200, between about 200 and about 300 nucleotides, between about 300 and about 400, or between about 400 and about 500 nucleotides long. However, shorter or longer oligonucleotides may be used. An oligonucleotide may be a single-stranded nucleic acid. However, in some embodiments a double-stranded oligonucleotide may be used as described herein. In certain embodiments, an oligonucleotide may be chemically synthesized as described in more detail below.

In some embodiments, an input nucleic acid (e.g., oligonucleotide) may be amplified before use. The resulting product may be double-stranded. In some embodiments, one of the strands of a double-stranded nucleic acid may be removed before use so that only a predetermined single strand is added to an assembly reaction.

In certain embodiments, each oligonucleotide may be designed to have a sequence that is identical to a different portion of the sequence of a predetermined target nucleic acid that is to be assembled. Accordingly, in some embodiments each oligonucleotide may have a sequence that is identical to a portion of one of the two strands of a double-stranded target nucleic acid. For clarity, the two complementary strands of a double stranded nucleic acid are referred to herein as the positive (P) and negative (N) strands. This designation is not intended to imply that the strands are sense and anti-sense strands of a coding sequence. They refer only to the two complementary strands of a nucleic acid (e.g., a target nucleic acid, an intermediate nucleic acid fragment, etc.) regardless of the sequence or function of the nucleic acid. Accordingly, in some embodiments a P strand may be a sense strand of a coding sequence, whereas in other embodiments a P strand may be an anti-sense strand of a coding sequence. According to the invention, a target nucleic acid may be either the P strand, the N strand, or a double-stranded nucleic acid comprising both the P and N strands.

It should be appreciated that different oligonucleotides may be designed to have different lengths. In some embodiments, one or more different oligonucleotides may have overlapping sequence regions (e.g., overlapping 5′ regions or overlapping 3′ regions). Overlapping sequence regions may be identical (i.e., corresponding to the same strand of the nucleic acid fragment) or complementary (i.e., corresponding to complementary strands of the nucleic acid fragment). The plurality of oligonucleotides may include one or more oligonucleotide pairs with overlapping identical sequence regions, one or more oligonucleotide pairs with overlapping complementary sequence regions, or a combination thereof. Overlapping sequences may be of any suitable length. For example, overlapping sequences may encompass the entire length of one or more nucleic acids used in an assembly reaction. Overlapping sequences may be between about 5 and about 500 nucleotides long (e.g., between about 10 and 100, between about 10 and 75, between about 10 and 50, about 20, about 25, about 30, about 35, about 40, about 45, about 50, etc.) However, shorter, longer or intermediate overlapping lengths may be used. It should be appreciated that overlaps between different input nucleic acids used in an assembly reaction may have different lengths.

In a multiplex oligonucleotide assembly reaction designed to generate a predetermined nucleic acid fragment, the combined sequences of the different oligonucleotides in the reaction may span the sequence of the entire nucleic acid fragment on either the positive strand, the negative strand, both strands, or a combination of portions of the positive strand and portions of the negative strand. The plurality of different oligonucleotides may provide either positive sequences, negative sequences, or a combination of both positive and negative sequences corresponding to the entire sequence of the nucleic acid fragment to be assembled. In some embodiments, the plurality of oligonucleotides may include one or more oligonucleotides having sequences identical to one or more portions of the positive sequence, and one or more oligonucleotides having sequences that are identical to one or more portions of the negative sequence of the nucleic acid fragment. One or more pairs of different oligonucleotides may include sequences that are identical to overlapping portions of the predetermined nucleic acid fragment sequence as described herein (e.g., overlapping sequence portions from the same or from complementary strands of the nucleic acid fragment). In some embodiments, the plurality of oligonucleotides includes a set of oligonucleotides having sequences that combine to span the entire positive sequence and a set oligonucleotides having sequences that combine to span the entire negative sequence of the predetermined nucleic acid fragment. However, in certain embodiments, the plurality of oligonucleotides may include one or more oligonucleotides with sequences that are identical to sequence portions on one strand (either the positive or negative strand) of the nucleic acid fragment, but no oligonucleotides with sequences that are complementary to those sequence portions. In one embodiment, a plurality of oligonucleotides includes only oligonucleotides having sequences identical to portions of the positive sequence of the predetermined nucleic acid fragment. In one embodiment, a plurality of oligonucleotides includes only oligonucleotides having sequences identical to portions of the negative sequence of the predetermined nucleic acid fragment. These oligonucleotides may be assembled by sequential ligation or in an extension-based reaction (e.g., if an oligonucleotide having a 3′ region that is complementary to one of the plurality of oligonucleotides is added to the reaction).

In one aspect, a nucleic acid fragment may be assembled in a polymerase-mediated assembly reaction from a plurality of oligonucleotides that are combined and extended in one or more rounds of polymerase-mediated extensions. In another aspect, a nucleic acid fragment may be assembled in a ligase-mediated reaction from a plurality of oligonucleotides that are combined and ligated in one or more rounds of ligase-mediated ligations. In another aspect, a nucleic acid fragment may be assembled in a non-enzymatic reaction (e.g., a chemical reaction) from a plurality of oligonucleotides that are combined and assembled in one or more rounds of non-enzymatic reactions. In some embodiments, a nucleic acid fragment may be assembled using a combination of polymerase, ligase, and/or non-enzymatic reactions. For example, both polymerase(s) and ligase(s) may be included in an assembly reaction mixture. Accordingly, a nucleic acid may be assembled via coupled amplification and ligation or ligation during amplification. The resulting nucleic acid fragment from each assembly technique may have a sequence that includes the sequences of each of the plurality of assembly oligonucleotides that were used as described herein. These assembly reactions may be referred to as primerless assemblies, since the target nucleic acid is generated by assembling the input oligonucleotides rather than being generated in an amplification reaction where the oligonucleotides act as amplification primers to amplify a pre-existing template nucleic acid molecule corresponding to the target nucleic acid.

Polymerase-based assembly techniques may involve one or more suitable polymerase enzymes that can catalyze a template-based extension of a nucleic acid in a 5′ to 3′ direction in the presence of suitable nucleotides and an annealed template. A polymerase may be thermostable. A polymerase may be obtained from recombinant or natural sources. In some embodiments, a thermostable polymerase from a thermophilic organism may be used. In some embodiments, a polymerase may include a 3′ 5′ exonuclease/proofreading activity. In some embodiments, a polymerase may have no, or little, proofreading activity (e.g., a polymerase may be a recombinant variant of a natural polymerase that has been modified to reduce its proofreading activity). Examples of thermostable DNA polymerases include, but are not limited to: Taq (a heat-stable DNA polymerase from the bacterium Thermus aquaticus); Pfu (a thermophilic DNA polymerase with a 3′→5′ exonuclease/proofreading activity from Pyrococcus furiosus, available from for example Promega); VentR® DNA Polymerase and VentR® (exo-) DNA Polymerase (thermophilic DNA polymerases with or without a 3′→5′ exonuclease/proofreading activity from Thermococcus litoralis; also known as Tli polymerase); Deep VentR® DNA Polymerase and Deep VentR® (exo-) DNA Polymerase (thermophilic DNA polymerases with or without a 3′→5′ exonuclease/proofreading activity from Pyrococcus species GB-D; available from New England Biolabs); KOD HiFi (a recombinant Thermococcus kodakaraensis KOD1 DNA polymerase with a 3′→5′ exonuclease/proofreading activity, available from Novagen); BIO-X-ACT (a mix of polymerases that possesses 5′-3′ DNA polymerase activity and 3′→5′ proofreading activity); Klenow Fragment (an N-terminal truncation of E. coli DNA Polymerase I which retains polymerase activity, but has lost the 5′→3′ exonuclease activity, available from, for example, Promega and NEB); Sequenase™ (T7 DNA polymerase deficient in 3′-5′ exonuclease activity); Phi29 (bacteriophage 29 DNA polymerase, may be used for rolling circle amplification, for example, in a TempliPhi™ DNA Sequencing Template Amplification Kit, available from Amersham Biosciences); TopoTaq™ (a hybrid polymerase that combines hyperstable DNA binding domains and the DNA unlinking activity of Methanopyrus topoisomerase, with no exonuclease activity, available from Fidelity Systems); TopoTaq HiFi which incorporates a proofreading domain with exonuclease activity; Phusion™ (a Pyrococcus-like enzyme with a processivity-enhancing domain, available from New England Biolabs); any other suitable DNA polymerase, or any combination of two or more thereof.

Ligase-based assembly techniques may involve one or more suitable ligase enzymes that can catalyze the covalent linking of adjacent 3′ and 5′ nucleic acid termini (e.g., a 5′ phosphate and a 3′ hydroxyl of nucleic acid(s) annealed on a complementary template nucleic acid such that the 3′ terminus is immediately adjacent to the 5′ terminus). Accordingly, a ligase may catalyze a ligation reaction between the 5′ phosphate of a first nucleic acid to the 3′ hydroxyl of a second nucleic acid if the first and second nucleic acids are annealed next to each other on a template nucleic acid). A ligase may be obtained from recombinant or natural sources. A ligase may be a heat-stable ligase. In some embodiments, a thermostable ligase from a thermophilic organism may be used. Examples of thermostable DNA ligases include, but are not limited to: Tth DNA ligase (from Thermus thermophilus, available from, for example, Eurogentec and GeneCraft); Pfu DNA ligase (a hyperthermophilic ligase from Pyrococcus furiosus); Taq ligase (from Thermus aquaticus), any other suitable heat-stable ligase, or any combination thereof. In some embodiments, one or more lower temperature ligases may be used (e.g., T4 DNA ligase). A lower temperature ligase may be useful for shorter overhangs (e.g., about 3, about 4, about 5, or about 6 base overhangs) that may not be stable at higher temperatures.

Non-enzymatic techniques can be used to ligate nucleic acids. For example, a 5′-end (e.g., the 5′ phosphate group) and a 3′-end (e.g., the 3′ hydroxyl) of one or more nucleic acids may be covalently linked together without using enzymes (e.g., without using a ligase). In some embodiments, non-enzymatic techniques may offer certain advantages over enzyme-based ligations. For example, non-enzymatic techniques may have a high tolerance of non-natural nucleotide analogues in nucleic acid substrates, may be used to ligate short nucleic acid substrates, may be used to ligate RNA substrates, and/or may be cheaper and/or more suited to certain automated (e.g., high throughput) applications.

Non-enzymatic ligation may involve a chemical ligation. In some embodiments, nucleic acid termini of two or more different nucleic acids may be chemically ligated. In some embodiments, nucleic acid termini of a single nucleic acid may be chemically ligated (e.g., to circularize the nucleic acid). It should be appreciated that both strands at a first double-stranded nucleic acid terminus may be chemically ligated to both strands at a second double-stranded nucleic acid terminus. However, in some embodiments only one strand of a first nucleic acid terminus may be chemically ligated to a single strand of a second nucleic acid terminus. For example, the 5′ end of one strand of a first nucleic acid terminus may be ligated to the 3′ end of one strand of a second nucleic acid terminus without the ends of the complementary strands being chemically ligated.

Accordingly, a chemical ligation may be used to form a covalent linkage between a 5′ terminus of a first nucleic acid end and a 3′ terminus of a second nucleic acid end, wherein the first and second nucleic acid ends may be ends of a single nucleic acid or ends of separate nucleic acids. In one aspect, chemical ligation may involve at least one nucleic acid substrate having a modified end (e.g., a modified 5′ and/or 3′ terminus) including one or more chemically reactive moieties that facilitate or promote linkage formation. In some embodiments, chemical ligation occurs when one or more nucleic acid termini are brought together in close proximity (e.g., when the termini are brought together due to annealing between complementary nucleic acid sequences). Accordingly, annealing between complementary 3′ or 5′ overhangs (e.g., overhangs generated by restriction enzyme cleavage of a double-stranded nucleic acid) or between any combination of complementary nucleic acids that results in a 3′ terminus being brought into close proximity with a 5′ terminus (e.g., the 3′ and 5′ termini are adjacent to each other when the nucleic acids are annealed to a complementary template nucleic acid) may promote a template-directed chemical ligation. Examples of chemical reactions may include, but are not limited to, condensation, reduction, and/or photo-chemical ligation reactions. It should be appreciated that in some embodiments chemical ligation can be used to produce naturally-occurring phosphodiester internucleotide linkages, non-naturally-occurring phosphamide pyrophosphate internucleotide linkages, and/or other non-naturally-occurring internucleotide linkages.

In some embodiments, the process of chemical ligation may involve one or more coupling agents to catalyze the ligation reaction. A coupling agent may promote a ligation reaction between reactive groups in adjacent nucleic acids (e.g., between a 5′-reactive moiety and a 3′-reactive moiety at adjacent sites along a complementary template). In some embodiments, a coupling agent may be a reducing reagent (e.g., ferricyanide), a condensing reagent such (e.g., cyanoimidazole, cyanogen bromide, carbodiimide, etc.), or irradiation (e.g., UV irradiation for photo-ligation).

In some embodiments, a chemical ligation may be an autoligation reaction that does not involve a separate coupling agent. In autoligation, the presence of a reactive group on one or more nucleic acids may be sufficient to catalyze a chemical ligation between nucleic acid termini without the addition of a coupling agent (see, for example, Xu Y & Kool E T, 1997, Tetrahedron Lett. 38:5595-8). Non-limiting examples of these reagent-free ligation reactions may involve nucleophilic displacements of sulfur on bromoacetyl, tosyl, or iodo-nucleoside groups (see, for example, Xu Y et al., 2001, Nat Biotech 19:148-52). Nucleic acids containing reactive groups suitable for autoligation can be prepared directly on automated synthesizers (see, for example, Xu Y & Kool E T, 1999, Nuc. Acids Res. 27:875-81). In some embodiments, a phosphorothioate at a 3′ terminus may react with a leaving group (such as tosylate or iodide) on a thymidine at an adjacent 5′ terminus. In some embodiments, two nucleic acid strands bound at adjacent sites on a complementary target strand may undergo auto-ligation by displacement of a 5′-end iodide moiety (or tosylate) with a 3′-end sulfur moiety. Accordingly, in some embodiments the product of an autoligation may include a non-naturally-occurring internucleotide linkage (e.g., a single oxygen atom may be replaced with a sulfur atom in the ligated product).

In some embodiments, a synthetic nucleic acid duplex can be assembled via chemical ligation in a one step reaction involving simultaneous chemical ligation of nucleic acids on both strands of the duplex. For example, a mixture of 5′-phosphorylated oligonucleotides corresponding to both strands of a target nucleic acid may be chemically ligated by a) exposure to heat (e.g., to 97° C.) and slow cooling to form a complex of annealed oligonucleotides, and b) exposure to cyanogen bromide or any other suitable coupling agent under conditions sufficient to chemically ligate adjacent 3′ and 5′ ends in the nucleic acid complex.

In some embodiments, a synthetic nucleic acid duplex can be assembled via chemical ligation in a two step reaction involving separate chemical ligations for the complementary strands of the duplex. For example, each strand of a target nucleic acid may be ligated in a separate reaction containing phosphorylated oligonucleotides corresponding to the strand that is to be ligated and non-phosphorylated oligonucleotides corresponding to the complementary strand. The non-phosphorylated oligonucleotides may serve as a template for the phosphorylated oligonucleotides during a chemical ligation (e.g. using cyanogen bromide). The resulting single-stranded ligated nucleic acid may be purified and annealed to a complementary ligated single-stranded nucleic acid to form the target duplex nucleic acid (see, for example, Shabarova Z A et al., 1991, Nuc. Acids Res. 19:4247-51).

Aspects of the invention may be used to enhance different types of nucleic acid assembly reactions (e.g., multiplex nucleic acid assembly reactions). Aspects of the invention may be used in combination with one or more assembly reactions described in, for example, Carr et al., 2004, Nucleic Acids Research, Vol. 32, No 20, e162 (9 pages); Richmond et al., 2004, Nucleic Acids Research, Vol. 32, No 17, pp. 5011-5018; Caruthers et al., 1972, J. Mol. Biol. 72, 475-492; Hecker et al., 1998, Biotechniques 24:256-260; Kodumal et al., 2004, PNAS Vol. 101, No. 44, pp. 15573-15578; Tian et al., 2004, Nature, Vol. 432, pp. 1050-1054; and U.S. Pat. Nos. 6,008,031 and 5,922,539, the disclosures of which are incorporated herein by reference. Certain embodiments of multiplex nucleic acid assembly reactions for generating a predetermined nucleic acid fragment are illustrated with reference to FIGS. 1-4. It should be appreciated that multiplex nucleic acid assembly reactions may be performed in any suitable format, including in a reaction tube, in a multi-well plate, on a surface, on a column, in a microfluidic device (e.g., a microfluidic tube), a capillary tube, etc.

It should be appreciated that the reference to complementary nucleic acids or complementary nucleic acid regions herein refers to nucleic acids or regions thereof that have sequences which are reverse complements of each other so that they can hybridize in an antiparallel fashion typical of natural DNA.

FIG. 1 shows one embodiment of a plurality of oligonucleotides that may be assembled in a polymerase-based multiplex oligonucleotide assembly reaction. FIG. 1A shows two groups of oligonucleotides (Group P and Group N) that have sequences of portions of the two complementary strands of a nucleic acid fragment to be assembled. Group P includes oligonucleotides with positive strand sequences (P₁, P₂, . . . Pₙ₋₁, Pₙ, Pₙ₊₁, . . . P_{T}, shown from 5′→3′ on the positive strand). Group N includes oligonucleotides with negative strand sequences (N_{T}, . . . , Nₙ₊₁, Nₙ, Nₙ₋₁, . . . , N₂, N₁, shown from 5′→3′ on the negative strand). In this example, none of the P group oligonucleotides overlap with each other and none of the N group oligonucleotides overlap with each other. However, in some embodiments, one or more of the oligonucleotides within the S or N group may overlap. Furthermore, FIG. 1A shows gaps between consecutive oligonucleotides in Group P and gaps between consecutive oligonucleotides in Group N. However, each P group oligonucleotide (except for P₁) and each N group oligonucleotide (except for N_{T}) overlaps with complementary regions of two oligonucleotides from the complementary group of oligonucleotides. P₁ and N_{T} overlap with a complementary region of only one oligonucleotide from the other group (the complementary 3′-most oligonucleotides N₁ and P_{T}, respectively). FIG. 1B shows a structure of an embodiment of a Group P or Group N oligonucleotide represented in FIG. 1A. This oligonucleotide includes a 5′ region that is complementary to a 5′ region of a first oligonucleotide from the other group, a 3′ region that is complementary to a 3′ region of a second oligonucleotide from the other group, and a core or central region that is not complementary to any oligonucleotide sequence from the other group (or its own group). This central region is illustrated as the B region in FIG. 1B. The sequence of the B region may be different for each different oligonucleotide. As defined herein, the B region of an oligonucleotide in one group corresponds to a gap between two consecutive oligonucleotides in the complementary group of oligonucleotides. It should be noted that the 5′-most oligonucleotide in each group (P₁ in Group P and N_{T} in Group N) does not have a 5′ region that is complementary to the 5′ region of any other oligonucleotide in either group. Accordingly, the 5′-most oligonucleotides (P₁ and N_{T}) that are illustrated in FIG. 1A each have a 3′ complementary region and a 5′ non-complementary region (the B region of FIG. 1B), but no 5′ complementary region. However, it should be appreciated that any one or more of the oligonucleotides in Group P and/or Group N (including all of the oligonucleotides in Group P and/or Group N) can be designed to have no B region. In the absence of a B region, a 5′-most oligonucleotide has only the 3′ complementary region (meaning that the entire oligonucleotide is complementary to the 3′ region of the 3′-most oligonucleotide from the other group (e.g., the 3′ region of N₁ or P_{T} shown in FIG. 1A). In the absence of a B region, one of the other oligonucleotides in either Group P or Group N has only a 5′ complementary region and a 3′ complementary region (meaning that the entire oligonucleotide is complementary to the 5′ and 3′ sequence regions of the two overlapping oligonucleotides from the complementary group). In some embodiments, only a subset of oligonucleotides in an assembly reaction may include B regions. It should be appreciated that the length of the 5′, 3′, and B regions may be different for each oligonucleotide. However, for each oligonucleotide the length of the 5′ region is the same as the length of the complementary 5′ region in the 5′ overlapping oligonucleotide from the other group. Similarly, the length of the 3′ region is the same as the length of the complementary 3′ region in the 3′ overlapping oligonucleotide from the other group. However, in certain embodiments a 3′-most oligonucleotide may be designed with a 3′ region that extends beyond the 5′ region of the 5′-most oligonucleotide. In this embodiment, an assembled product may include the 5′ end of the 5′-most oligonucleotide, but not the 3′ end of the 3′-most oligonucleotide that extends beyond it.

FIG. 1C illustrates a subset of the oligonucleotides from FIG. 1A, each oligonucleotide having a 5′, a 3′, and an optional B region. Oligonucleotide Pₙ is shown with a 5′ region that is complementary to (and can anneal to) the 5′ region of oligonucleotide Nₙ₋₁. Oligonucleotide Pₙ also has a 3′ region that is complementary to (and can anneal to) the 3′ region of oligonucleotide Nₙ. Nₙ is also shown with a 5′ region that is complementary (and can anneal to) the 5′ region of oligonucleotide Pₙ₊₁. This pattern could be repeated for all of oligonucleotides P₂ to P_{T} and N₁ to N_{T-1} (with the 5′-most oligonucleotides only having 3′ complementary regions as discussed herein). If all of the oligonucleotides from Group P and Group N are mixed together under appropriate hybridization conditions, they may anneal to form a long chain such as the oligonucleotide complex illustrated in FIG. 1A. However, subsets of the oligonucleotides may form shorter chains and even oligonucleotide dimers with annealed 5′ or 3′ regions. It should be appreciated that many copies of each oligonucleotide are included in a typical reaction mixture. Accordingly, the resulting hybridized reaction mixture may contain a distribution of different oligonucleotide dimers and complexes. Polymerase-mediated extension of the hybridized oligonucleotides results in a template-based extension of the 3′ ends of oligonucleotides that have annealed 3′ regions. Accordingly, polymerase-mediated extension of the oligonucleotides shown in FIG. 1C would result in extension of the 3′ ends only of oligonucleotides Pₙ and Nₙ generating extended oligonucleotides containing sequences that are complementary to all the regions of Nₙ and Pₙ, respectively. Extended oligonucleotide products with sequences complementary to all of Nₙ₋₁ and Pₙ₊₁ would not be generated unless oligonucleotides Pₙ₋₁ and Nₙ₊₁ were included in the reaction mixture. Accordingly, if all of the oligonucleotide sequences in a plurality of oligonucleotides are to be incorporated into an assembled nucleic acid fragment using a polymerase, the plurality of oligonucleotides should include 5′-most oligonucleotides that are at least complementary to the entire 3′ regions of the 3′-most oligonucleotides. In some embodiments, the 5′-most oligonucleotides also may have 5′ regions that extend beyond the 3′ ends of the 3′-most oligonucleotides as illustrated in FIG. 1A. In some embodiments, a ligase also may be added to ligate adjacent 5′ and 3′ ends that may be formed upon 3′ extension of annealed oligonucleotides in an oligonucleotide complex such as the one illustrated in FIG. 1A.

When assembling a nucleic acid fragment using a polymerase, a single cycle of polymerase extension extends oligonucleotide pairs with annealed 3′ regions. Accordingly, if a plurality of oligonucleotides were annealed to form an annealed complex such as the one illustrated in FIG. 1A, a single cycle of polymerase extension would result in the extension of the 3′ ends of the P₁/N₁, P₂/N₂, . . . , Pₙ₋₁/Nₙ₋₁, Pₙ/Nₙ, Pₙ₊₁/Nₙ₊₁, . . . , P_{T}/N_{T} oligonucleotide pairs. In one embodiment, a single molecule could be generated by ligating the extended oligonucleotide dimers. In one embodiment, a single molecule incorporating all of the oligonucleotide sequences may be generated by performing several polymerase extension cycles.

In one embodiment, FIG. 1D illustrates two cycles of polymerase extension (separated by a denaturing step and an annealing step) and the resulting nucleic acid products. It should be appreciated that several cycles of polymerase extension may be required to assemble a single nucleic acid fragment containing all the sequences of an initial plurality of oligonucleotides. In one embodiment, a minimal number of extension cycles for assembling a nucleic acid may be calculated as log₂n, where n is the number of oligonucleotides being assembled. In some embodiments, progressive assembly of the nucleic acid may be achieved without using temperature cycles. For example, an enzyme capable of rolling circle amplification may be used (e.g., phi 29 polymerase) when a circularized nucleic acid (e.g., oligonucleotide) complex is used as a template to produce a large amount of circular product for subsequent processing using MutS or a MutS homolog as described herein. In step 1 of FIG. 1D, annealed oligonucleotide pairs Pₙ/Nₙ and Pₙ₊₁/Nₙ₊₁ are extended to form oligonucleotide dimer products incorporating the sequences covered by the respective oligonucleotide pairs. For example, Pₙ is extended to incorporate sequences that are complementary to the B and 5′ regions of Nₙ (indicated as N′ₙ in FIG. 1D). Similarly, Nₙ₊₁ is extended to incorporate sequences that are complementary to the 5′ and B regions of Pₙ₊₁ (indicated as P′ₙ₊₁ in FIG. 1D). These dimer products may be denatured and reannealed to form the starting material of step 2 where the 3′ end of the extended Pₙ oligonucleotide is annealed to the 3′ end of the extended Nₙ₊₁ oligonucleotide. This product may be extended in a polymerase-mediated reaction to form a product that incorporates the sequences of the four oligonucleotides (Pₙ, Nₙ, Pₙ+1, Nₙ₊₁). One strand of this extended product has a sequence that includes (in 5′ to 3′ order) the 5′, B, and 3′ regions of Pₙ, the complement of the B region of Nₙ, the 5′, B, and 3′ regions of Pₙ₊₁, and the complements of the B and 5′ regions of Nₙ₊₁. The other strand of this extended product has the complementary sequence. It should be appreciated that the 3′ regions of Pₙ and Nₙ are complementary, the 5′ regions of Nₙ and Pₙ₊₁ are complementary, and the 3′ regions of Pₙ₊₁ and Nₙ₊₁ are complementary. It also should be appreciated that the reaction products shown in FIG. 1D are a subset of the reaction products that would be obtained using all of the oligonucleotides of Group P and Group N. A first polymerase extension reaction using all of the oligonucleotides would result in a plurality of overlapping oligonucleotide dimers from P₁/N₁ to P_{T}/N_{T}. Each of these may be denatured and at least one of the strands could then anneal to an overlapping complementary strand from an adjacent (either 3′ or 5′) oligonucleotide dimer and be extended in a second cycle of polymerase extension as shown in FIG. 1D. Subsequent cycles of denaturing, annealing, and extension produce progressively larger products including a nucleic acid fragment that includes the sequences of all of the initial oligonucleotides. It should be appreciated that these subsequent rounds of extension also produce many nucleic acid products of intermediate length. The reaction product may be complex since not all of the 3′ regions may be extended in each cycle. Accordingly, unextended oligonucleotides may be available in each cycle to anneal to other unextended oligonucleotides or to previously extended oligonucleotides. Similarly, extended products of different sizes may anneal to each other in each cycle. Accordingly, a mixture of extended products of different sizes covering different regions of the sequence may be generated along with the nucleic acid fragment covering the entire sequence. This mixture also may contain any remaining unextended oligonucleotides.

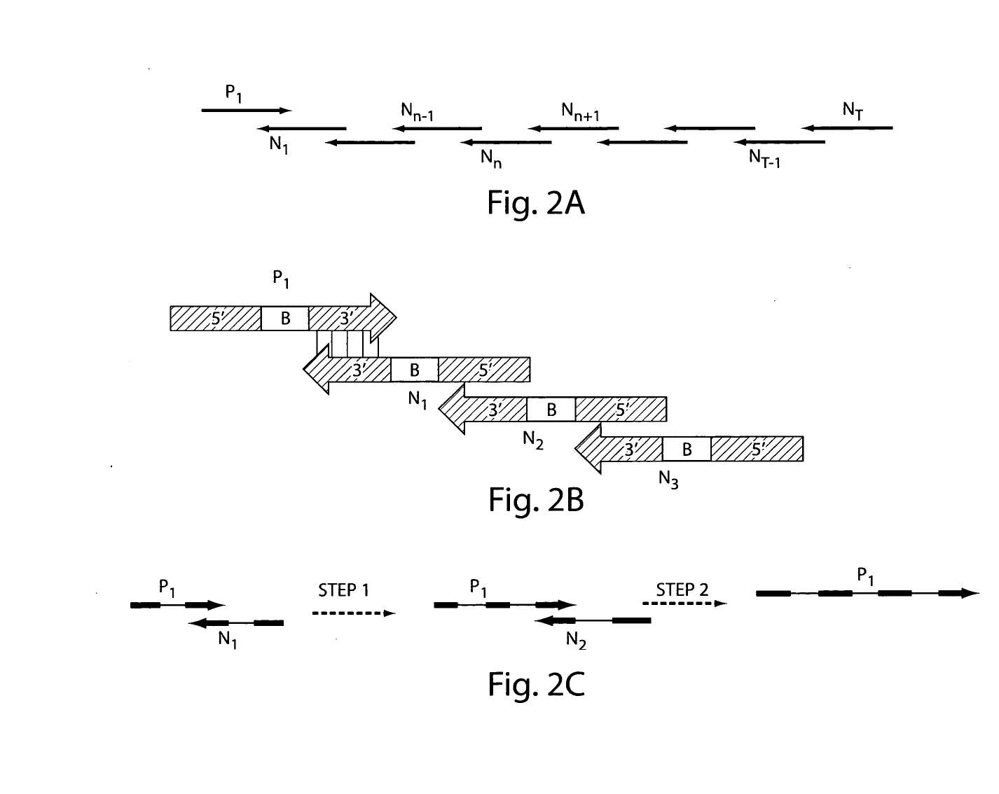

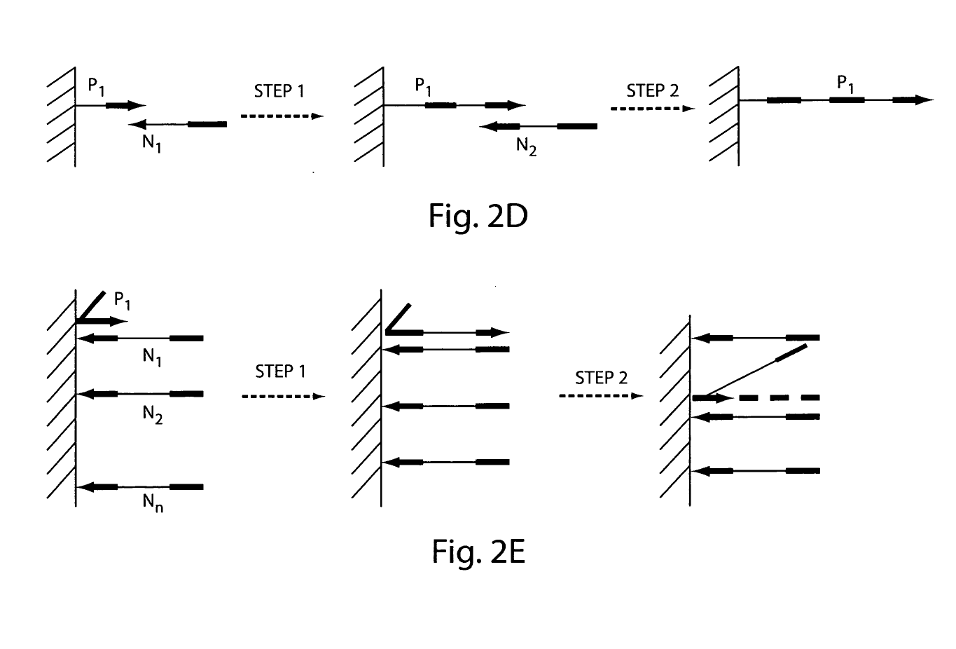

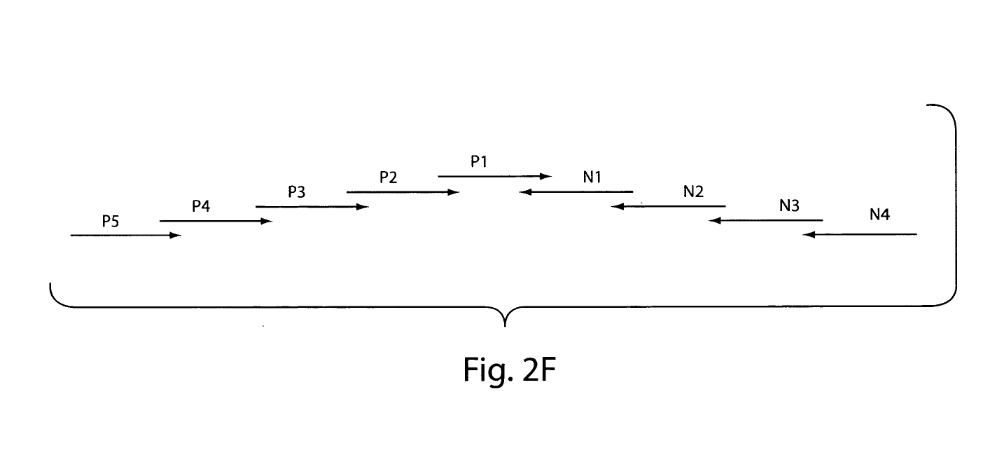

FIG. 2 shows an embodiment of a plurality of oligonucleotides that may be assembled in a directional polymerase-based multiplex oligonucleotide assembly reaction. In this embodiment, only the 5′-most oligonucleotide of Group P may be provided. In contrast to the example shown in FIG. 1, the remainder of the sequence of the predetermined nucleic acid fragment is provided by oligonucleotides of Group N. The 3′-most oligonucleotide of Group N (N1) has a 3′ region that is complementary to the 3′ region of P₁ as shown in FIG. 2B. However, the remainder of the oligonucleotides in Group N have overlapping (but non-complementary) 3′ and 5′ regions as illustrated in FIG. 2B for oligonucleotides N1-N3. Each Group N oligonucleotide (e.g., Nₙ) overlaps with two adjacent oligonucleotides: one overlaps with the 3′ region (Nₙ₋₁) and one with the 5′ region (Nₙ₊₁), except for N₁ that overlaps with the 3′ regions of P₁ (complementary overlap) and N2 (non-complementary overlap), and NT that overlaps only with N_{T-1}. It should be appreciated that all of the overlaps shown in FIG. 2A between adjacent oligonucleotides N₂ to N_{T-1} are non-complementary overlaps between the 5′ region of one oligonucleotide and the 3′ region of the adjacent oligonucleotide illustrated in a 3′ to 5′ direction on the N strand of the predetermined nucleic acid fragment. It also should be appreciated that each oligonucleotide may have 3′, B, and 5′regions of different lengths (including no B region in some embodiments). In some embodiments, none of the oligonucleotides may have B regions, meaning that the entire sequence of each oligonucleotide may overlap with the combined 5′ and 3′ region sequences of its two adjacent oligonucleotides.

Assembly of a predetermined nucleic acid fragment from the plurality of oligonucleotides shown in FIG. 2A may involve multiple cycles of polymerase-mediated extension. Each extension cycle may be separated by a denaturing and an annealing step. FIG. 2C illustrates the first two steps in this assembly process. In step 1, annealed oligonucleotides P₁ and N₁ are extended to form an oligonucleotide dimer. P₁ is shown with a 5′ region that is non-complementary to the 3′ region of N₁ and extends beyond the 3′ region of N₁ when the oligonucleotides are annealed. However, in some embodiments, P₁ may lack the 5′ non-complementary region and include only sequences that overlap with the 3′ region of N₁. The product of P₁ extension is shown after step 1 containing an extended region that is complementary to the 5′ end of N₁. The single strand illustrated in FIG. 2C may be obtained by denaturing the oligonucleotide dimer that results from the extension of P₁/N₁ in step 1. The product of P₁ extension is shown annealed to the 3′ region of N₂. This annealed complex may be extended in step 2 to generate an extended product that now includes sequences complementary to the B and 5′ regions of N₂. Again, the single strand illustrated in FIG. 2C may be obtained by denaturing the oligonucleotide dimer that results from the extension reaction of step 2. Additional cycles of extension may be performed to further assemble a predetermined nucleic acid fragment. In each cycle, extension results in the addition of sequences complementary to the B and 5′ regions of the next Group N oligonucleotide. Each cycle may include a denaturing and annealing step. However, the extension may occur under the annealing conditions. Accordingly, in one embodiment, cycles of extension may be obtained by alternating between denaturing conditions (e.g., a denaturing temperature) and annealing/extension conditions (e.g., an annealing/extension temperature). In one embodiment, T (the number of group N oligonucleotides) may determine the minimal number of temperature cycles used to assemble the oligonucleotides. However, in some embodiments, progressive extension may be achieved without temperature cycling. For example, an enzyme capable promoting rolling circle amplification may be used (e.g., TempliPhi). It should be appreciated that a reaction mixture containing an assembled predetermined nucleic acid fragment also may contain a distribution of shorter extension products that may result from incomplete extension during one or more of the cycles or may be the result of an P₁/N₁ extension that was initiated after the first cycle.

FIG. 2D illustrates an example of a sequential extension reaction where the 5′-most P₁ oligonucleotide is bound to a support and the Group N oligonucleotides are unbound. The reaction steps are similar to those described for FIG. 2C. However, an extended predetermined nucleic acid fragment will be bound to the support via the 5′-most P₁ oligonucleotide. Accordingly, the complementary strand (the negative strand) may readily be obtained by denaturing the bound fragment and releasing the negative strand. In some embodiments, the attachment to the support may be labile or readily reversed (e.g., using light, a chemical reagent, a pH change, etc.) and the positive strand also may be released. Accordingly, either the positive strand, the negative strand, or the double-stranded product may be obtained. FIG. 2E illustrates an example of a sequential reaction where P₁ is unbound and the Group N oligonucleotides are bound to a support. The reaction steps are similar to those described for FIG. 2C. However, an extended predetermined nucleic acid fragment will be bound to the support via the 5′-most N_{T} oligonucleotide. Accordingly, the complementary strand (the positive strand) may readily be obtained by denaturing the bound fragment and releasing the positive strand. In some embodiments, the attachment to the support may be labile or readily reversed (e.g., using light, a chemical reagent, a pH change, etc.) and the negative strand also may be released. Accordingly, either the positive strand, the negative strand, or the double-stranded product may be obtained.

It should be appreciated that other configurations of oligonucleotides may be used to assemble a nucleic acid via two or more cycles of polymerase-based extension. In many configurations, at least one pair of oligonucleotides have complementary 3′ end regions. FIG. 2F illustrates an example where an oligonucleotide pair with complementary 3′ end regions is flanked on either side by a series of oligonucleotides with overlapping non-complementary sequences. The oligonucleotides illustrated to the right of the complementary pair have overlapping 3′ and 5′ regions (with the 3′ region of one oligonucleotide being identical to the 5′ region of the adjacent oligonucleotide) that corresponding to a sequence of one strand of the target nucleic acid to be assembled. The oligonucleotides illustrated to the left of the complementary pair have overlapping 3′ and 5′ regions (with the 3′ region of one oligonucleotide being identical to the 5′ region of the adjacent oligonucleotide) that correspond to a sequence of the complementary strand of the target nucleic acid. These oligonucleotides may be assembled via sequential polymerase-based extension reactions as described herein (see also, for example, Xiong et al., 2004, Nucleic Acids Research, Vol. 32, No. 12, e98, 10 pages, the disclosure of which is incorporated by reference herein). It should be appreciated that different numbers and/or lengths of oligonucleotides may be used on either side of the complementary pair. Accordingly, the illustration of the complementary pair as the central pair in FIG. 2F is not intended to be limiting as other configuration of a complementary oligonucleotide pair flanked by a different number of non-complementary pairs on either side may be used according to methods of the invention.

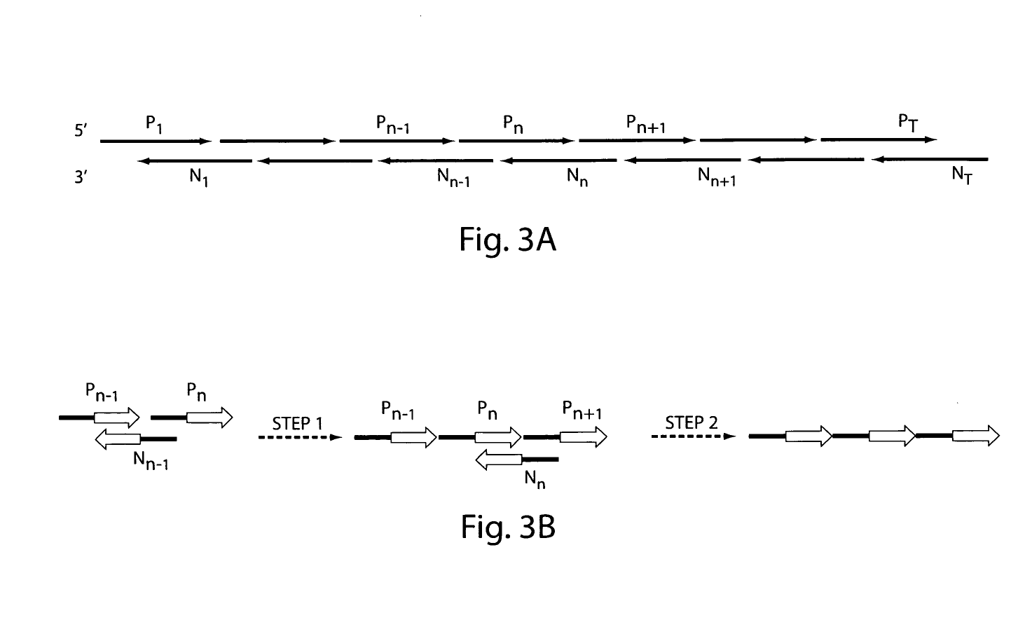

FIG. 3 shows an embodiment of a plurality of oligonucleotides that may be assembled in a ligase reaction. FIG. 3A illustrates the alignment of the oligonucleotides showing that they do not contain gaps (i.e., no B region as described herein). Accordingly, the oligonucleotides may anneal to form a complex with no nucleotide gaps between the 3′ and 5′ ends of the annealed oligonucleotides in either Group P or Group N. These oligonucleotides provide a suitable template for assembly using a ligase under appropriate reaction conditions. However, it should be appreciated that these oligonucleotides also may be assembled using a polymerase-based assembly reaction as described herein. FIG. 3B shows two individual ligation reactions. These reactions are illustrated in two steps. However, it should be appreciated that these ligation reactions may occur simultaneously or sequentially in any order and may occur as such in a reaction maintained under constant reaction conditions (e.g., with no temperature cycling) or in a reaction exposed to several temperature cycles. For example, the reaction illustrated in step 2 may occur before the reaction illustrated in step 1. In each ligation reaction illustrated in FIG. 3B, a Group N oligonucleotide is annealed to two adjacent Group P oligonucleotides (due to the complementary 5′ and 3′ regions between the P and N oligonucleotides), providing a template for ligation of the adjacent P oligonucleotides. Although not illustrated, ligation of the N group oligonucleotides also may proceed in similar manner to assemble adjacent N oligonucleotides that are annealed to their complementary P oligonucleotide. Assembly of the predetermined nucleic acid fragment may be obtained through ligation of all of the oligonucleotides to generate a double stranded product. However, in some embodiments, a single stranded product of either the positive or negative strand may be obtained. In certain embodiments, a plurality of oligonucleotides may be designed to generate only single-stranded reaction products in a ligation reaction. For example, a first group of oligonucleotides (of either Group P or Group N) may be provided to cover the entire sequence on one strand of the predetermined nucleic acid fragment (on either the positive or negative strand). In contrast, a second group of oligonucleotides (from the complementary group to the first group) may be designed to be long enough to anneal to complementary regions in the first group but not long enough to provide adjacent 5′ and 3′ ends between oligonucleotides in the second group. This provides substrates that are suitable for ligation of oligonucleotides from the first group but not the second group. The result is a single-stranded product having a sequence corresponding to the oligonucleotides in the first group. Again, as with other assembly reactions described herein, a ligase reaction mixture that contains an assembled predetermined nucleic acid fragment also may contain a distribution of smaller fragments resulting from the assembly of a subset of the oligonucleotides.

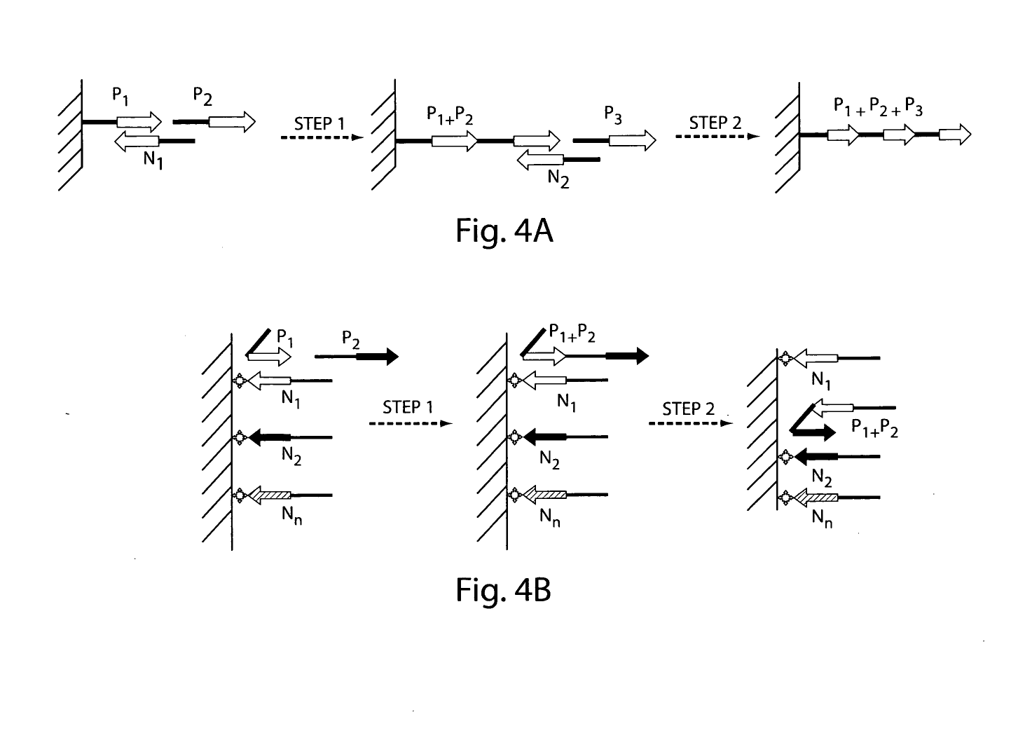

FIG. 4 shows an embodiment of a ligase-based assembly where one or more of the plurality of oligonucleotides is bound to a support. In FIG. 4A, the 5′ most oligonucleotide of the P group oligonucleotides is bound to a support. Ligation of adjacent oligonucleotides in the 5′ to 3′ direction results in the assembly of a predetermined nucleic acid fragment. FIG. 4A illustrates an example where adjacent oligonucleotides P₂ and P₃ are added sequentially. However, the ligation of any two adjacent oligonucleotides from Group P may occur independently and in any order in a ligation reaction mixture. For example, when P₁ is ligated to the 5′ end of N₂, N₂ may be in the form of a single oligonucleotide or it already may be ligated to one or more downstream oligonucleotides (N₃, N₄, etc.). It should be appreciated that for a ligation assembly bound to a support, either the 5′-most (e.g., P₁ for Group P, or N_{T} for Group N) or the 3′-most (e.g., P_{T} for Group P, or N₁ for Group N) oligonucleotide may be bound to a support since the reaction can proceed in any direction. In some embodiments, a predetermined nucleic acid fragment may be assembled with a central oligonucleotide (i.e., neither the 5′-most or the 3′-most) that is bound to a support provided that the attachment to the support does not interfere with ligation.

FIG. 4B illustrates an example where a plurality of N group oligonucleotides are bound to a support and a predetermined nucleic acid fragment is assembled from P group oligonucleotides that anneal to their complementary support-bound N group oligonucleotides. Again, FIG. 4B illustrates a sequential addition. However, adjacent P group oligonucleotides may be ligated in any order. Also, the bound oligonucleotides may be attached at their 5′ end, 3′ end, or at any other position provided that the attachment does not interfere with their ability to bind to complementary 5′ and 3′ regions on the oligonucleotides that are being assembled. This reaction may involve one or more reaction condition changes (e.g., temperature cycles) so that ligated oligonucleotides bound to one immobilized N group oligonucleotide can be dissociated from the support and bind to a different immobilized N group oligonucleotide to provide a substrate for ligation to another P group oligonucleotide.

As with other assembly reactions described herein, support-bound ligase reactions (e.g., those illustrated in FIG. 4B) that generate a full length predetermined nucleic acid fragment also may generate a distribution of smaller fragments resulting from the assembly of subsets of the oligonucleotides. A support used in any of the assembly reactions described herein (e.g., polymerase-based, ligase-based, or other assembly reaction) may include any suitable support medium. A support may be solid, porous, a matrix, a gel, beads, beads in a gel, etc. A support may be of any suitable size. A solid support may be provided in any suitable configuration or shape (e.g., a chip, a bead, a gel, a microfluidic channel, a planar surface, a spherical shape, a column, etc.).

As illustrated herein, different oligonucleotide assembly reactions may be used to assemble a plurality of overlapping oligonucleotides (with overlaps that are either 5′/5′, 3′/3′, 5′/3′, complementary, non-complementary, or a combination thereof). Many of these reactions include at least one pair of oligonucleotides (the pair including one oligonucleotide from a first group or P group of oligonucleotides and one oligonucleotide from a second group or N group of oligonucleotides) have overlapping complementary 3′ regions. However, in some embodiments, a predetermined nucleic acid may be assembled from non-overlapping oligonucleotides using blunt-ended ligation reactions. In some embodiments, the order of assembly of the non-overlapping oligonucleotides may be biased by selective phosphorylation of different 5′ ends. In some embodiments, size purification may be used to select for the correct order of assembly. In some embodiments, the correct order of assembly may be promoted by sequentially adding appropriate oligonucleotide substrates into the reaction (e.g., the ligation reaction).

In order to obtain a full-length nucleic acid fragment from a multiplex oligonucleotide assembly reaction, a purification step may be used to remove starting oligonucleotides and/or incompletely assembled fragments. In some embodiments, a purification step may involve chromatography, electrophoresis, or other physical size separation technique. In certain embodiments, a purification step may involve amplifying the full length product. For example, a pair of amplification primers (e.g., PCR primers) that correspond to the predetermined 5′ and 3′ ends of the nucleic acid fragment being assembled will preferentially amplify full length product in an exponential fashion. It should be appreciated that smaller assembled products may be amplified if they contain the predetermined 5′ and 3′ ends. However, such smaller-than-expected products containing the predetermined 5′ and 3′ ends should only be generated if an error occurred during assembly (e.g., resulting in the deletion or omission of one or more regions of the target nucleic acid) and may be removed by size fractionation of the amplified product. Accordingly, a preparation containing a relatively high amount of full length product may be obtained directly by amplifying the product of an assembly reaction using primers that correspond to the predetermined 5′ and 3′ ends. In some embodiments, additional purification (e.g., size selection) techniques may be used to obtain a more purified preparation of amplified full-length nucleic acid fragment.

When designing a plurality of oligonucleotides to assemble a predetermined nucleic acid fragment, the sequence of the predetermined fragment will be provided by the oligonucleotides as described herein. However, the oligonucleotides may contain additional sequence information that may be removed during assembly or may be provided to assist in subsequent manipulations of the assembled nucleic acid fragment. Examples of additional sequences include, but are not limited to, primer recognition sequences for amplification (e.g., PCR primer recognition sequences), restriction enzyme recognition sequences, recombination sequences, other binding or recognition sequences, labeled sequences, etc. In some embodiments, one or more of the 5′-most oligonucleotides, one or more of the 3′-most oligonucleotides, or any combination thereof, may contain one or more additional sequences. In some embodiments, the additional sequence information may be contained in two or more adjacent oligonucleotides on either strand of the predetermined nucleic acid sequence. Accordingly, an assembled nucleic acid fragment may contain additional sequences that may be used to connect the assembled fragment to one or more additional nucleic acid fragments (e.g., one or more other assembled fragments, fragments obtained from other sources, vectors, etc.) via ligation, recombination, polymerase-mediated assembly, etc. In some embodiments, purification may involve cloning one or more assembled nucleic acid fragments. The cloned product may be screened (e.g., sequenced, analyzed for an insert of the expected size, etc.).

In some embodiments, a nucleic acid fragment assembled from a plurality of oligonucleotides may be combined with one or more additional nucleic acid fragments using a polymerase-based and/or a ligase-based extension reaction similar to those described herein for oligonucleotide assembly. Accordingly, one or more overlapping nucleic acid fragments may be combined and assembled to produce a larger nucleic acid fragment as described herein. In certain embodiments, double-stranded overlapping oligonucleotide fragments may be combined. However, single-stranded fragments, or combinations of single-stranded and double-stranded fragments may be combined as described herein. A nucleic acid fragment assembled from a plurality of oligonucleotides may be of any length depending on the number and length of the oligonucleotides used in the assembly reaction. For example, a nucleic acid fragment (either single-stranded or double-stranded) assembled from a plurality of oligonucleotides may be between 50 and 1,000 nucleotides long (for example, about 70 nucleotides long, between 100 and 500 nucleotides long, between 200 and 400 nucleotides long, about 200 nucleotides long, about 300 nucleotides long, about 400 nucleotides long, etc.). One or more such nucleic acid fragments (e.g., with overlapping 3′ and/or 5′ ends) may be assembled to form a larger nucleic acid fragment (single-stranded or double-stranded) as described herein.

A full length product assembled from smaller nucleic acid fragments also may be isolated or purified as described herein (e.g., using a size selection, cloning, selective binding or other suitable purification procedure). In addition, any assembled nucleic acid fragment (e.g., full-length nucleic acid fragment) described herein may be amplified (prior to, as part of, or after, a purification procedure) using appropriate 5′ and 3′ amplification primers.

Synthetic Oligonucleotides:

It should be appreciated that the terms P Group and N Group oligonucleotides are used herein for clarity purposes only, and to illustrate several embodiments of multiplex oligonucleotide assembly. The Group P and Group N oligonucleotides described herein are interchangeable, and may be referred to as first and second groups of oligonucleotides corresponding to sequences on complementary strands of a target nucleic acid fragment.

Oligonucleotides may be synthesized using any suitable technique. For example, oligonucleotides may be synthesized on a column or other support (e.g., a chip). Examples of chip-based synthesis techniques include techniques used in synthesis devices or methods available from Combimatrix, Agilent, Affymetrix, or other sources. A synthetic oligonucleotide may be of any suitable size, for example between 10 and 1,000 nucleotides long (e.g., between 10 and 200, 200 and 500, 500 and 1,000 nucleotides long, or any combination thereof). An assembly reaction may include a plurality of oligonucleotides, each of which independently may be between 10 and 200 nucleotides in length (e.g., between 20 and 150, between 30 and 100, 30 to 90, 30-80, 30-70, 30-60, 35-55, 40-50, or any intermediate number of nucleotides). However, one or more shorter or longer oligonucleotides may be used in certain embodiments.

Oligonucleotides may be provided as single stranded synthetic products. However, in some embodiments, oligonucleotides may be provided as double-stranded preparations including an annealed complementary strand. Oligonucleotides may be molecules of DNA, RNA, PNA, or any combination thereof. A double-stranded oligonucleotide may be produced by amplifying a single-stranded synthetic oligonucleotide or other suitable template (e.g., a sequence in a nucleic acid preparation such as a nucleic acid vector or genomic nucleic acid). Accordingly, a plurality of oligonucleotides designed to have the sequence features described herein may be provided as a plurality of single-stranded oligonucleotides having those feature, or also may be provided along with complementary oligonucleotides.

In some embodiments, an oligonucleotide may be amplified using an appropriate primer pair with one primer corresponding to each end of the oligonucleotide (e.g., one that is complementary to the 3′ end of the oligonucleotide and one that is identical to the 5′ end of the oligonucleotide). In some embodiments, an oligonucleotide may be designed to contain a central assembly sequence (designed to be incorporated into the target nucleic acid) flanked by a 5′ amplification sequence (e.g., a 5′ universal sequence) and a 3′ amplification sequence (e.g., a 3′ universal sequence). Amplification primers (e.g., between 10 and 50 nucleotides long, between 15 and 45 nucleotides long, about 25 nucleotides long, etc.) corresponding to the flanking amplification sequences may be used to amplify the oligonucleotide (e.g., one primer may be complementary to the 3′ amplification sequence and one primer may have the same sequence as the 5′ amplification sequence). The amplification sequences then may be removed from the amplified oligonucleotide using any suitable technique to produce an oligonucleotide that contains only the assembly sequence.

In some embodiments, a plurality of different oligonucleotides (e.g., about 5, 10, 50, 100, or more) with different central assembly sequences may have identical 5′ amplification sequences and identical 3′ amplification sequences. These oligonucleotides can all be amplified in the same reaction using the same amplification primers.

A preparation of an oligonucleotide designed to have a certain sequence may include oligonucleotide molecules having the designed sequence in addition to oligonucleotide molecules that contain errors (e.g., that differ from the designed sequence at least at one position). A sequence error may include one or more nucleotide deletions, additions, substitutions (e.g., transversion or transition), inversions, duplications, or any combination of two or more thereof. Oligonucleotide errors may be generated during oligonucleotide synthesis. Different synthetic techniques may be prone to different error profiles and frequencies. In some embodiments, error rates may vary from 1/10 to 1/200 errors per base depending on the synthesis protocol that is used. However, in some embodiments lower error rates may be achieved. Also, the types of errors may depend on the synthetic techniques that are used. For example, in some embodiments chip-based oligonucleotide synthesis may result in relatively more deletions than column-based synthetic techniques.

In some embodiments, one or more oligonucleotide preparations may be processed to remove (or reduce the frequency of) error-containing oligonucleotides. In some embodiments, a hybridization technique may be used wherein an oligonucleotide preparation is hybridized under stringent conditions one or more times to an immobilized oligonucleotide preparation designed to have a complementary sequence. Oligonucleotides that do not bind may be removed in order to selectively or specifically remove oligonucleotides that contain errors that would destabilize hybridization under the conditions used. It should be appreciated that this processing may not remove all error-containing oligonucleotides since many have only one or two sequence errors and may still bind to the immobilized oligonucleotides with sufficient affinity for a fraction of them to remain bound through this selection processing procedure.

In some embodiments of the invention, a sliding clamp technique may be used for enriching error-free oligonucleotides after hybridization of oligonucleotides that are designed to be complementary, provided that the ends are “blocked” to inhibit dissociation of the clamped form of MutS from any heteroduplexes that are present.

In some embodiments, a nucleic acid binding protein or recombinase (e.g., RecA) may be included in one or more of the oligonucleotide processing steps to improve the selection of error free oligonucleotides. For example, by preferentially promoting the hybridization of oligonucleotides that are completely complementary with the immobilized oligonucleotides, the amount of error containing oligonucleotides that are bound may be reduced. As a result, this oligonucleotide processing procedure may remove more error-containing oligonucleotides and generate an oligonucleotide preparation that has a lower error frequency (e.g., with an error rate of less than 1/50, less than 1/100, less than 1/200, less than 1/300, less than 1/400, less than 1/500, less than 1/1,000, or less than 1/2,000 errors per base.

A plurality of oligonucleotides used in an assembly reaction may contain preparations of synthetic oligonucleotides, single-stranded oligonucleotides, double-stranded oligonucleotides, amplification products, oligonucleotides that are processed to remove (or reduce the frequency of) error-containing variants, etc., or any combination of two or more thereof.

In some aspects, synthetic oligonucleotides synthesized on an array (e.g., a chip) are not amplified prior to assembly. In some embodiments, a polymerase-based or ligase-based assembly using non-amplified oligonucleotides may be performed in a microfluidic device. Oligonucleotides synthesized on an array may be cleaved and added to any suitable assembly reaction without amplification. These oligonucleotides can be synthesized without a 5′ and/or 3′ amplification sequence (e.g., without one or more sequences that correspond to a universal primer sequence). Accordingly, these oligonucleotides can be used directly in an assembly reaction without removing one or more flanking amplification sequences. In some embodiments, about 3, 4, 5, 6, 7, 8, 9, 10, or more non-amplified oligonucleotides can be assembled (if they have appropriate overlapping regions as described herein) in a single reaction. The assembled nucleic acid then may be amplified using 5′ and 3′ primers. In some embodiments, the 5′ and 3′ primers correspond to target nucleic acid sequences at the 5′ and 3′ end of the assembled nucleic acid. However, in some embodiments, each of the 5′-most and 3′-most oligonucleotides that were used in the assembly reaction contain a flanking universal primer sequence that can be used to amplify the assembled nucleic acid.

In some aspects, a synthetic oligonucleotide may be amplified prior to use. Either strand of a double-stranded amplification product may be used as an assembly oligonucleotide and added to an assembly reaction as described herein. A synthetic oligonucleotide may be amplified using a pair of amplification primers (e.g., a first primer that hybridizes to the 3′ region of the oligonucleotide and a second primer that hybridizes to the 3′ region of the complement of the oligonucleotide). The oligonucleotide may be synthesized on a support such as a chip (e.g., using an ink-jet-based synthesis technology). In some embodiments, the oligonucleotide may be amplified while it is still attached to the support. In some embodiments, the oligonucleotide may be removed or cleaved from the support prior to amplification. The two strands of a double-stranded amplification product may be separated and isolated using any suitable technique. In some embodiments, the two strands may be differentially labeled (e.g., using one or more different molecular weight, affinity, fluorescent, electrostatic, magnetic, and/or other suitable tags). The different labels may be used to purify and/or isolate one or both strands. In some embodiments, biotin may be used as a purification tag. In some embodiments, the strand that is to be used for assembly may be directly purified (e.g., using an affinity or other suitable tag). In some embodiments, the complementary strand is removed (e.g., using an affinity or other suitable tag) and the remaining strand is used for assembly.

In some embodiments, a synthetic oligonucleotide may include a central assembly sequence flanked by 5′ and 3′ amplification sequences. The central assembly sequence is designed for incorporation into an assembled nucleic acid. The flanking sequences are designed for amplification and are not intended to be incorporated into the assembled nucleic acid. The flanking amplification sequences may be used as universal primer sequences to amplify a plurality of different assembly oligonucleotides that share the same amplification sequences but have different central assembly sequences. In some embodiments, the flanking sequences are removed after amplification to produce an oligonucleotide that contains only the assembly sequence.

In some embodiments, one of the two amplification primers may be biotinylated. The nucleic acid strand that incorporates this biotinylated primer during amplification can be affinity purified using streptavidin (e.g., bound to a bead, column, or other surface). In some embodiments, the amplification primers also may be designed to include certain sequence features that can be used to remove the primer regions after amplification in order to produce a single-stranded assembly oligonucleotide that includes the assembly sequence without the flanking amplification sequences.

In some embodiments, the non-biotinylated strand may be used for assembly. The assembly oligonucleotide may be purified by removing the biotinylated complementary strand. In some embodiments, the amplification sequences may be removed if the non-biotinylated primer includes a dU at its 3′ end, and if the amplification sequence recognized by (i.e., complementary to) the biotinylated primer includes at most three of the four nucleotides and the fourth nucleotide is present in the assembly sequence at (or adjacent to) the junction between the amplification sequence and the assembly sequence. After amplification, the double-stranded product is incubated with T4 DNA polymerase (or other polymerase having a suitable editing activity) in the presence of the fourth nucleotide (without any of the nucleotides that are present in the amplification sequence recognized by the biotinylated primer) under appropriate reaction conditions. Under these conditions, the 3′ nucleotides are progressively removed through to the nucleotide that is not present in the amplification sequence (referred to as the fourth nucleotide above). As a result, the amplification sequence that is recognized by the biotinylated primer is removed. The biotinylated strand is then removed. The remaining non-biotinylated strand is then treated with uracil-DNA glycosylase (UDG) to remove the non-biotinylated primer sequence. This technique generates a single-stranded assembly oligonucleotide without the flanking amplification sequences. It should be appreciated that this technique may be used to process a single amplified oligonucleotide preparation or a plurality of different amplified oligonucleotides in a single reaction if they share the same amplification sequence features described above.

In some embodiments, the biotinylated strand may be used for assembly. The assembly oligonucleotide may be obtained directly by isolating the biotinylated strand. In some embodiments, the amplification sequences may be removed if the biotinylated primer includes a dU at its 3′ end, and if the amplification sequence recognized by (i.e., complementary to) the non-biotinylated primer includes at most three of the four nucleotides and the fourth nucleotide is present in the assembly sequence at (or adjacent to) the junction between the amplification sequence and the assembly sequence. After amplification, the double-stranded product is incubated with T4 DNA polymerase (or other polymerase having a suitable editing activity) in the presence of the fourth nucleotide (without any of the nucleotides that are present in the amplification sequence recognized by the non-biotinylated primer) under appropriate reaction conditions. Under these conditions, the 3′ nucleotides are progressively removed through to the nucleotide that is not present in the amplification sequence (referred to as the fourth nucleotide above). As a result, the amplification sequence that is recognized by the non-biotinylated primer is removed. The biotinylated strand is then isolated (and the non-biotinylated strand is removed). The isolated biotinylated strand is then treated with UDG to remove the biotinylated primer sequence. This technique generates a single-stranded assembly oligonucleotide without the flanking amplification sequences. It should be appreciated that this technique may be used to process a single amplified oligonucleotide preparation or a plurality of different amplified oligonucleotides in a single reaction if they share the same amplification sequence features described above.

It should be appreciated that the biotinylated primer may be designed to anneal to either the synthetic oligonucleotide or to its complement for the amplification and purification reactions described above. Similarly, the non-biotinylated primer may be designed to anneal to either strand provided it anneals to the strand that is complementary to the strand recognized by the biotinylated primer.

In certain embodiments, it may be helpful to include one or more modified oligonucleotides in an assembly reaction. An oligonucleotide may be modified by incorporating a modified-base (e.g., a nucleotide analog) during synthesis, by modifying the oligonucleotide after synthesis, or any combination thereof. Examples of modifications include, but are not limited to, one or more of the following: universal bases such as nitroindoles, dP and dK, inosine, uracil; halogenated bases such as BrdU; fluorescent labeled bases; non-radioactive labels such as biotin (as a derivative of dT) and digoxigenin (DIG); 2,4-Dinitrophenyl (DNP); radioactive nucleotides; post-coupling modification such as dR-NH₂ (deoxyribose-NH₂); Acridine (6-chloro-2-methoxiacridine); and spacer phosphoramides which are used during synthesis to add a spacer ‘arm’ into the sequence, such as C3, C8 (octanediol), C9, C12, HEG (hexaethlene glycol) and C18.

It should be appreciated that one or more nucleic acid binding proteins or recombinases are preferably not included in a post-assembly fidelity optimization technique (e.g., a screening technique using a MutS or MutS homolog), because the optimization procedure involves removing error-containing nucleic acids via the production and removal of heteroduplexes. Accordingly, any nucleic acid binding proteins or recombinases (e.g., RecA) that were included in the assembly steps is preferably removed (e.g., by inactivation, column purification or other suitable technique) after assembly and prior to fidelity optimization.

Applications:

Aspects of the invention may be useful for a range of applications involving the production and/or use of synthetic nucleic acid libraries. As described herein, the invention provides methods for producing synthetic nucleic acid libraries with increased fidelity and/or for reducing the cost and/or time of synthetic assembly reactions. Aspects of the invention also provide methods for assembling libraries that express polypeptides that do not have undesirable structural or functional properties. The resulting assembled nucleic acids may be amplified in vitro (e.g., using PCR, LCR, or any suitable amplification technique), amplified in vivo (e.g., via cloning into a suitable vector), isolated and/or purified. An assembled nucleic acid library (alone or cloned into a vector) may be transformed into a host cell (e.g., a prokaryotic, eukaryotic, insect, mammalian, or other host cell). In some embodiments, the host cell may be used to propagate the nucleic acid. In certain embodiments, individual nucleic acids may be integrated into the genome of the host cell. In some embodiments, the nucleic acid may replace a corresponding nucleic acid region on the genome of the cell (e.g., via homologous recombination). Accordingly, nucleic acid libraries may be used to produce recombinant organisms. In some embodiments, a nucleic acid library may include entire genomes or large fragments of a genome that are used to replace all or part of the genome of a host organism. Recombinant organisms also may be used for a variety of research, industrial, agricultural, and/or medical applications.

A host cell may be prokaryotic (e.g., bacterial such as E. coli or B. subtilis) or eukaryotic (e.g., a yeast, mammal or insect cell). For example, host cells may be bacterial cells (e.g., Escherichia coli, Bacillus subtilis, Mycobacterium spp., M. tuberculosis, or other suitable bacterial cells), yeast cells (for example, Saccharomyces spp., Picchia spp., Candida spp., or other suitable yeast species, e.g., S. cerevisiae, C. albicans, S. pombe, etc.), Xenopus cells, mouse cells, monkey cells, human cells, insect cells (e.g., SF9 cells and Drosophila cells), worm cells (e.g., Caenorhabditis spp.), plant cells, or other suitable cells, including for example, transgenic or other recombinant cell lines. In addition, a number of heterologous cell lines may be used, such as Chinese Hamster Ovary cells (CHO). It should be appreciated that when integrating a nucleic acid into a eukaryotic genome (e.g., a mammalian genome) care should be taken to select sites that will allow sufficient expression (e.g., silenced regions of the genome should be avoided, whereas a site comprising an enhancer may be appropriate).

Many of the techniques described herein can be used together, applying enrichment steps at one or more points to produce libraries containing long nucleic acid molecules having defined predetermined sequences. Correct sequence enrichment techniques of the invention can be applied to double-stranded nucleic acids of any size. For example, enrichment techniques using sliding clamp configurations of mismatch binding proteins may be used with oligonucleotide duplexes, nucleic acid fragments of less than 100 to more than 10,000 base pairs in length (e.g., 100 mers to 500 mers, 500 mers to 1,000 mers, 1,000 mers to 5,000 mers, 5,000 mers to 10,000 mers, etc.). In some embodiments, methods described herein may be used during the assembly of large nucleic acid molecules (for example, larger than 5,000 nucleotides in length, e.g., longer than about 10,000, longer than about 25,000, longer than about 50,000, longer than about 75,000, longer than about 100,000 nucleotides, etc.). In an exemplary embodiment, methods described herein may be used during the assembly of an entire genome (or a large fragment thereof, e.g., about 10%, 20%, 30%, 40%, 50%, 60%, 70%, 80%, 90%, or more) of an organism (e.g., of a viral, bacterial, yeast, or other prokaryotic or eukaryotic organism), optionally incorporating specific modifications into the sequence at one or more desired locations.

Any of the nucleic acid products (e.g., including individual nucleic acids and nucleic acid libraries that are amplified, cloned, purified, isolated, etc.) may be packaged in any suitable format (e.g., in a stable buffer, lyophilized, etc.) for storage and/or shipping (e.g., for shipping to a distribution center or to a customer). Similarly, any of the host cells (e.g., cells transformed with a vector or having a modified genome) may be prepared in a suitable buffer for storage and or transport (e.g., for distribution to a customer). In some embodiments, cells may be frozen. However, other stable cell preparations also may be used.

Host cells may be grown and expanded in culture. Host cells may be used for expressing one or more RNAs or polypeptides of interest (e.g., therapeutic, industrial, agricultural, and/or medical proteins). The expressed polypeptides may be natural polypeptides or non-natural polypeptides. The polypeptides may be isolated or purified for subsequent use.

Accordingly, nucleic acid molecules generated using methods of the invention can be incorporated into a vector. The vector may be a cloning vector or an expression vector. In some embodiments, the vector may be a viral vector. A viral vector may comprise nucleic acid sequences capable of infecting target cells. Similarly, in some embodiments, a prokaryotic expression vector operably linked to an appropriate promoter system can be used to transform target cells. In other embodiments, a eukaryotic vector operably linked to an appropriate promoter system can be used to transfect target cells or tissues.

Transcription and/or translation of the constructs described herein may be carried out in vitro (i.e. using cell-free systems) or in vivo (i.e. expressed in cells). In some embodiments, cell lysates may be prepared. In certain embodiments, expressed RNAs or polypeptides may be isolated or purified. Nucleic acids of the invention also may be used to add detection and/or purification tags to expressed polypeptides or fragments thereof. Examples of polypeptide-based fusion/tag include, but are not limited to, hexa-histidine (His⁶) Myc and HA, and other polypeptides with utility, such as GFP, GST, MBP, chitin and the like. In some embodiments, polypeptides may comprise one or more unnatural amino acid residue(s).

Libraries of the invention may be used to screen for one or more polypeptides (e.g., proteins) that have one or more structural or functional properties of interest. A nucleic acid encoding a polypeptide of interest may be isolated and cloned into a different vector (e.g., with a different promoter, origin of replication) and/or cell (e.g., into a different species and/or integrated into the genome of a host cell). A polypeptide of interest may be isolated and or purified from a cell or cell lysate.

In some embodiments, antibodies can be made against polypeptides or fragment(s) thereof encoded by one or more synthetic nucleic acids.

In certain embodiments, synthetic nucleic acids may be provided as libraries for screening in research and development (e.g., to identify potential therapeutic proteins or peptides, to identify potential protein targets for drug development, etc.)

In some embodiments, a synthetic nucleic acid may be used as a therapeutic (e.g., for gene therapy, or for gene regulation). For example, a synthetic nucleic acid may be administered to a patient in an amount sufficient to express a therapeutic amount of a protein. In other embodiments, a synthetic nucleic acid may be administered to a patient in an amount sufficient to regulate (e.g., down-regulate) the expression of a gene.

It should be appreciated that different acts or embodiments described herein may be performed independently and may be performed at different locations in the United States or outside the United States. For example, each of the acts of receiving an order for a target nucleic acid, analyzing a target nucleic acid sequence, designing one or more starting nucleic acids (e.g., oligonucleotides), synthesizing starting nucleic acid(s), purifying starting nucleic acid(s), assembling starting nucleic acid(s), isolating assembled nucleic acid(s), confirming the sequence of assembled nucleic acid(s), manipulating assembled nucleic acid(s) (e.g., amplifying, cloning, inserting into a host genome, etc.), and any other acts or any parts of these acts may be performed independently either at one location or at different sites within the United States or outside the United States. In some embodiments, an assembly procedure may involve a combination of acts that are performed at one site (in the United States or outside the United States) and acts that are performed at one or more remote sites (within the United States or outside the United States).

Automated Applications:

Aspects of the invention may include automating one or more acts described herein. For example, a sequence analysis may be automated in order to generate a synthesis strategy automatically. The synthesis strategy may include i) the design of the starting nucleic acids that are to be assembled into the target nucleic acid, ii) the choice of the assembly technique(s) to be used, iii) the number of rounds of assembly and error screening or sequencing steps to include, and/or decisions relating to subsequent processing of an assembled target nucleic acid. Similarly, one or more steps of an assembly reaction may be automated using one or more automated sample handling devices (e.g., one or more automated liquid or fluid handling devices). For example, the synthesis and optional selection of starting nucleic acids (e.g., oligonucleotides) may be automated using an nucleic acid synthesizer and automated procedures. Automated devices and procedures may be used to mix reaction reagents, including one or more of the following: starting nucleic acids, buffers, enzymes (e.g., one or more ligases and/or polymerases), nucleotides, nucleic acid binding proteins or recombinases, salts, and any other suitable agents such as stabilizing agents. Automated devices and procedures also may be used to control the reaction conditions. For example, an automated thermal cycler may be used to control reaction temperatures and any temperature cycles that may be used. Similarly, subsequent purification and analysis of assembled nucleic acid products may be automated. For example, fidelity optimization steps (e.g., a MutS error screening procedure) may be automated using appropriate sample processing devices and associated protocols. Sequencing also may be automated using a sequencing device and automated sequencing protocols. Additional steps (e.g., amplification, cloning, etc.) also may be automated using one or more appropriate devices and related protocols. It should be appreciated that one or more of the device or device components described herein may be combined in a system (e.g. a robotic system). Assembly reaction mixtures (e.g., liquid reaction samples) may be transferred from one component of the system to another using automated devices and procedures (e.g., robotic manipulation and/or transfer of samples and/or sample containers, including automated pipetting devices, etc.). The system and any components thereof may be controlled by a control system.

Accordingly, acts of the invention may be automated using, for example, a computer system (e.g., a computer controlled system). A computer system on which aspects of the invention can be implemented may include a computer for any type of processing (e.g., sequence analysis and/or automated device control as described herein). However, it should be appreciated that certain processing steps may be provided by one or more of the automated devices that are part of the assembly system. In some embodiments, a computer system may include two or more computers. For example, one computer may be coupled, via a network, to a second computer. One computer may perform sequence analysis. The second computer may control one or more of the automated synthesis and assembly devices in the system. In other aspects, additional computers may be included in the network to control one or more of the analysis or processing acts. Each computer may include a memory and processor. The computers can take any form, as the aspects of the present invention are not limited to being implemented on any particular computer platform. Similarly, the network can take any form, including a private network or a public network (e.g., the Internet). Display devices can be associated with one or more of the devices and computers. Alternatively, or in addition, a display device may be located at a remote site and connected for displaying the output of an analysis in accordance with the invention. Connections between the different components of the system may be via wire, wireless transmission, satellite transmission, any other suitable transmission, or any combination of two or more of the above.

In accordance with one embodiment of the present invention for use on a computer system it is contemplated that sequence information (e.g., a target sequence, a processed analysis of the target sequence, etc.) can be obtained and then sent over a public network, such as the Internet, to a remote location to be processed by computer to produce any of the various types of outputs discussed herein (e.g., in connection with oligonucleotide design). However, it should be appreciated that the aspects of the present invention described herein are not limited in that respect, and that numerous other configurations are possible. For example, all of the analysis and processing described herein can alternatively be implemented on a computer that is attached locally to a device, an assembly system, or one or more components of an assembly system. As a further alternative, as opposed to transmitting sequence information (e.g., a target sequence, a processed analysis of the target sequence, etc.) over a communication medium (e.g., the network), the information can be loaded onto a computer readable medium that can then be physically transported to another computer for processing in the manners described herein. In another embodiment, a combination of two or more transmission/delivery techniques may be used. It also should be appreciated that computer implementable programs for performing a sequence analysis or controlling one or more of the devices, systems, or system components described herein also may be transmitted via a network or loaded onto a computer readable medium as described herein. Accordingly, aspects of the invention may involve performing one or more steps within the United States and additional steps outside the United States. In some embodiments, sequence information (e.g., a customer order) may be received at one location (e.g., in one country) and sent to a remote location for processing (e.g., in the same country or in a different country (e.g., for sequence analysis to determine a synthesis strategy and/or design oligonucleotides). In certain embodiments, a portion of the sequence analysis may be performed at one site (e.g., in one country) and another portion at another site (e.g., in the same country or in another country). In some embodiments, different steps in the sequence analysis may be performed at multiple sites (e.g., all in one country or in several different countries). The results of a sequence analysis then may be sent to a further site for synthesis. However, in some embodiments, different synthesis and quality control steps may be performed at more than one site (e.g., within one county or in two or more countries). An assembled nucleic acid then may be shipped to a further site (e.g., either to a central shipping center or directly to a client).

Each of the different aspects, embodiments, or acts of the present invention described herein can be independently automated and implemented in any of numerous ways. For example, each aspect, embodiment, or act can be independently implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments of the present invention comprises at least one computer-readable medium (e.g., a computer memory, a floppy disk, a compact disk, a tape, etc.) encoded with a computer program (i.e., a plurality of instructions), which, when executed on a processor, performs one or more of the above-discussed functions of the present invention. The computer-readable medium can be transportable such that the program stored thereon can be loaded onto any computer system resource to implement one or more functions of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer readable medium, the computer implemented processes may, during the course of their execution, receive input manually (e.g., from a user).

Accordingly, overall system-level control of the assembly devices or components described herein may be performed by a system controller which may provide control signals to the associated nucleic acid synthesizers, liquid handling devices, thermal cyclers, sequencing devices, associated robotic components, as well as other suitable systems for performing the desired input/output or other control functions. Thus, the system controller along with any device controllers together form a controller that controls the operation of a nucleic acid assembly system. The controller may include a general purpose data processing system, which can be a general purpose computer, or network of general purpose computers, and other associated devices, including communications devices, modems, and/or other circuitry or components necessary to perform the desired input/output or other functions. The controller can also be implemented, at least in part, as a single special purpose integrated circuit (e.g., ASIC) or an array of ASICs, each having a main or central processor section for overall, system-level control, and separate sections dedicated to performing various different specific computations, functions and other processes under the control of the central processor section. The controller can also be implemented using a plurality of separate dedicated programmable integrated or other electronic circuits or devices, e.g., hard wired electronic or logic circuits such as discrete element circuits or programmable logic devices. The controller can also include any other components or devices, such as user input/output devices (monitors, displays, printers, a keyboard, a user pointing device, touch screen, or other user interface, etc.), data storage devices, drive motors, linkages, valve controllers, robotic devices, vacuum and other pumps, pressure sensors, detectors, power supplies, pulse sources, communication devices or other electronic circuitry or components, and so on. The controller also may control operation of other portions of a system, such as automated client order processing, quality control, packaging, shipping, billing, etc., to perform other suitable functions known in the art but not described in detail herein.

Business Applications:

Aspects of the invention may be useful to streamline nucleic acid library assembly reactions. Accordingly, aspects of the invention relate to marketing methods, compositions, kits, devices, and systems related to nucleic acid libraries using assembly techniques described herein.

Aspects of the invention may be useful for reducing the time and/or cost of production, commercialization, and/or development of synthetic nucleic acid libraries, and/or related compositions. Accordingly, aspects of the invention relate to business methods that involve collaboratively (e.g., with a partner) or independently marketing one or more methods, kits, compositions, devices, or systems for analyzing and/or assembling synthetic nucleic acid libraries as described herein. For example, certain embodiments of the invention may involve marketing a procedure and/or associated devices or systems involving nucleic acid libraries (e.g., libraries that encode filtered polypeptide sequences). In some embodiments, synthetic nucleic acids, libraries of synthetic nucleic acids, host cells containing synthetic nucleic acids, expressed polypeptides or proteins, etc., also may be marketed.

Marketing may involve providing information and/or samples relating to methods, kits, compositions, devices, and/or systems described herein. Potential customers or partners may be, for example, companies in the pharmaceutical, biotechnology and agricultural industries, as well as academic centers and government research organizations or institutes. Business applications also may involve generating revenue through sales and/or licenses of methods, kits, compositions, devices, and/or systems of the invention.

### EXAMPLES

### Example 1

### Nucleic Acid Fragment Assembly

Gene assembly via a 2-step PCR method: In step (1), a primerless assembly of oligonucleotides is performed and in step (2) an assembled nucleic acid fragment is amplified in a primer-based amplification.

A 993 base long promoter>EGFP construct was assembled from 50-mer abutting oligonucleotides using a 2-step PCR assembly.

Mixed oligonucleotide pools were prepared as follows: 36 overlapping 50-mer oligonucleotides and two 5′ terminal 59-mers were separated into 4 pools, each corresponding to overlapping 200-300 nucleotide segments of the final construct. The total oligonucleotide concentration in each pool was 5 μM.

A primerless PCR extension reaction was used to stitch (assemble) overlapping oligonucleotides in each pool. The PCR extension reaction mixture was as follows:

| | | |
|---|---|---|
| oligonucleotide pool (5 μM total) | 1.0 | μl (˜25 nM final each) |
| dNTP (10 mM each) | 0.5 | μl (250 μM final each) |
| Pfu buffer (10x) | 2.0 | μl |
| Pfu polymerase (2.5 U/μl) | 0.5 | μl |
| dH₂O to 20 μl | | |

Assembly was achieved by cycling this mixture through several rounds of denaturing, annealing, and extension reactions as follows:
start 2 min. 95° C.
30 cycles of 95° C. 30 sec., 65° C. 30 sec., 72° C. 1 min.
final 72° C. 2 min. extension step

The resulting product was exposed to amplification conditions to amplify the desired nucleic acid fragments (sub-segments of 200-300 nucleotides). The following PCR mix was used:

| | | |
|---|---|---|
| primerless PCR product | 1.0 | μl |
| primer 5′ (1.2 μM) | 5 | μl (300 nM final) |
| primer 3′ (1.2 μM) | 5 | μl (300 nM final) |
| dNTP (10 mM each) | 0.5 | μl (250 μM final each) |
| Pfu buffer (10x) | 2.0 | μl |
| Pfu polymerase (2.5 U/μl) | 0.5 | μl |
| dH₂O to 20 μl | | |

The following PCR cycle conditions were used:
start 2 min. 95° C.
35 cycles of 95° C. 30 sec., 65° C. 30 sec., 72° C. 1 min.
final 72° C. 2 min. extension step

The amplified sub-segments were assembled using another round of primerless PCR as follows. A diluted amplification product was prepared for each sub-segment by diluting each amplified sub-segment PCR product 1:10 (4 μl mix+36 μl dH₂O). This diluted mix was used as follows:

| | | |
|---|---|---|
| diluted sub-segment mix | 1.0 | μl |
| dNTP (10 mM each) | 0.5 | μl (250 μM final each) |
| Pfu buffer (10x) | 2.0 | μl |
| Pfu polymerase (2.5 U/μl) | 0.5 | μl |
| dH₂0 to 20 μl | | |

The following PCR cycle conditions were used:
start 2 min. 95° C.
30 cycles of 95° C. 30 sec., 65° C. 30 sec., 72° C. 1 min.
final 72° C. 2 min. extension step

The full-length 993 nucleotide long promoter>EGFP was amplified in the following PCR mix:

| | | |
|---|---|---|
| assembled sub-segments | 1.0 | μl |
| primer 5′ (1.2 μM) | 5 | μl (300 nM final) |
| primer 3′ (1.2 μM) | 5 | μl (300 nM final) |
| dNTP (10 mM each) | 0.5 | μl (250 μM final each) |
| Pfu buffer (10x) | 2.0 | μl |
| Pfu polymerase (2.5 U/μl) | 0.5 | μl |
| dH₂0 to 20 μl | | |

The following PCR cycle conditions were used:
start 2 min. 95° C.
35 cycles of 95° C. 30 sec., 65° C. 30 sec., 72° C. 1 min. final 72° C. 2 min. extension step

### Example 2

### Library Design for the Selection of Therapeutic Antibody Mimics

Certain embodiments of the invention may be exemplified by the design of a library for selecting therapeutic antibody mimics based on the tenth human fibronection type II domain (10Fn3), using pre-filtering for high solubility and low immunogenicity.

One possible library can be generated by randomizing twelve of the 94 amino-acid residues of 10Fn3, with the variability occurring in seven positions in loop BC (residues 23-29) and in five positions in loop DE (residues 52-56). The library will be made from two overlapping DNA fragments (“sub-libraries”), one encoding residues 1-47, and the other encoding residues 34-94. The library design and assembly may involve one or more of the following step.

1. An initial list of sequences will be generated for each sub-library by enumerating every possible permutation of the randomized positions. The resulting starting sub-libraries will contain 20⁷=10⁹ sequences (the N-terminal sub-library, “SL-N”) and 20⁵=10⁶ sequences (the C-terminal sub-library, “SL-C”).

2. A filtering step will be applied to each sub-library list that will remove all sequences that contain more than one tryptophan in the randomized region.

3. A filtering step will be applied to each sub-library list that will remove all sequences that contain one or more cysteines.

4. pI values will be calculated for each sequence on each list. All sequences with pI values between 6 and 9 will be removed from both lists.

5. Each sub-library list will be divided into two sublists. One list will contain the 1,000 sequences with the highest pI values (“SL-Nh” and “SL-Ch”); the other list will contain the 1,000 sequences with the lowest pI values (“SL-Nl” and “SL-Cl”).

6. The randomized region and the adjacent fixed positions for each of the 4,000 remaining sequences will be represented by a series of 9-mer, overlapping oligopeptides. Each of the peptides will be modeled into the peptide-binding site of all available MHC II structures. Each sequence that gave rise to an MHC-II-binding peptide will be removed from each list.

7. The remaining sequences on each list (SL-Nh, SL-Ch, SL-Nl, and SL-Cl) will be back-translated into DNA, optimized for codon usage and secondary-structure formation, and synthesized.

8. The physical DNA clones on each list (SL-Nh, SL-Ch, SL-Nl, and SL-Cl) will be combined to generate the four corresponding DNA pools, and will be PCR-amplified to 30 ug of DNA.

9. Pools will be combined pairwise: Pool H will result from combining pools SL-Nh and SL-Ch; pool L will result from combining pools SL-Nl and SL-Cl.

10. Pool H will be transformed into yeast strain EBY100 and recombined into a gapped plasmid used for yeast-surface display following standard protocol. Pool L will undergo the same procedure separately.

11. Transformed yeast cultures H and L will be grown separately and will have their complexity determined. Then the two cultures will be combined at same representation of each clone.

12. The resulting yeast library will be subjected to selection for binding to TNF-alpha using yeast-surface display, following standard protocols.

13. The selection is expected to yield a high proportion TNF-alpha-binding 10Fn3-like antibody mimics with high solubility and low immunogenicity.

### EQUIVALENTS

The present invention provides among other things methods for assembling large polynucleotide constructs and organisms having increased genomic stability. While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

### INCORPORATION BY REFERENCE

All publications, patents and sequence database entries mentioned herein, including those items listed below, are hereby incorporated by reference in their entirety as if each individual publication or patent was specifically and individually indicated to be incorporated by reference. In addition, the disclosures of application Ser. No. 11/332,657 (published as 2006/0160138) and provisional applications Ser. Nos. 60/801,842, 60/801,833, 60/801,834, all filed May 19, 2006, and Ser. No. 60/801,760, filed May 20, 2006, and the utility and PCT applications claiming priority thereto are incorporated herein by reference in their entirety. In case of conflict, the present application, including any definitions herein, will control.

1. A method for producing a library of nucleic acids that encode a pool of variant polypeptides having favorable biological or biophysical traits, the method comprising:
selecting a scaffold polypeptide;
selecting positions to be substituted and defining all possible substitutions;
excluding substitutions that are predicted or known to have unfavorable biological or biophysical traits; and
designing a library of nucleic acids that encode the non-excluded polypeptide sequences.

2. The method of claim 1 further comprising expressing the nucleic acids of the library and identifying polypeptides having favorable biological or biophysical traits in a functional screen, analyzing the identified polypeptides for amino acids or patterns of amino acids that confer the biological or biophysical trait, and redesigning the library based on that analysis.

3. The method of claim 2, wherein identifying polypeptides in a functional screen, analyzing the identified polypeptides and redesigning the library is repeated.

4. The method of claim 1, further comprising assembling the nucleic acid library.

5. The method of claim 1, wherein substitutions predicted to cause low solubility or low stability of the polypeptide are excluded.

6. The method of claim 1, wherein substitutions predicted to be immunogenic are excluded.

7. The method of claim 1, wherein substitutions predicted to be chemically reactive are excluded.

8. The method of claim 1, wherein substitutions predicted to cause unfavorable intracellular interactions are excluded.

9. The method of claim 1, wherein substitutions predicted to cause unfavorable extracellular interactions are excluded.

10. The method of claim 1, wherein the scaffold polypeptide is selected on the basis of its high stability, in vivo solubility, low immunogenicity, ease of expression, ease of purification in microbial systems; and/or monomeric state.

11. The method of claim 1, wherein positions are selected for substitution on the basis of their location in the polypeptide.

12. The method of claim 1, wherein the positions selected for substitution comprise one or more positions in a binding domain.

13. The method of claim 1, wherein the positions selected for substitution comprise one or more positions adjacent to a binding domain.

14. The method of claim 1, wherein the positions selected for substitution comprise one or more positions in a catalytic domain.

15. The method of claim 1, wherein the positions selected for substitution comprise one or more positions adjacent to a catalytic domain.

16. The method of claim 1, wherein the positions selected for substitution comprise one or more positions located on the surface of the folded polypeptide.

17. The method of claim 1, wherein the positions selected for substitution comprise one or more positions that are important for the function of the scaffold polypeptide.

18. The method of claim 4, wherein the library is assembled using a polymerase-based, ligase-based, and/or chemical-based assembly.

19. The method of claim 1, further comprising screening or selecting for a polypeptide having a favorable biological or biophysical trait.
